(19) United States
(12) Patent Application Publication
(10) Pub. No.: US 2026/0327396 A1
(43) Pub. Date: Oct. 22, 2026

(54) PROCESS FOR RECOVERY OF A POLYETHYLENE TEREPHTHALATE BASED POLYMER FROM A POLYMERIC MATERIAL

(71) Applicant: BASF SE, Ludwigshafen am Rhein (DE)

(72) Inventors: Sina WITZEL, Ludwigshafen am Rhein (DE); Hannah Stephanie MANGOLD, Ludwigshafen am Rhein (DE); Indre THIEL, Ludwigshafen am Rhein (DE); Bernhard Ulrich VON VACANO, Ludwigshafen am Rhein (DE); Ivan GARCIA ROMERO, Ludwigshafen am Rhein (DE)

(21) Appl. No.: 19/486,601

(22) PCT Filed: Jun. 18, 2024
(86) PCT No.: PCT/EP2024/066968

§ 371 Date: Nov. 21, 2025

(30) Foreign Application Priority Data
Jun. 19, 2023 (EP) 23180063.2

(51) Int. Cl. C08J 11/08

(52) U.S. Cl. CPC C08J 11/08; C08J 2367/02

(57) ABSTRACT

Disclosed herein are a process for recovery of a polyethylene terephthalate based polymer from a polymeric material, a polyalkylene terephthalate based polymer obtained from the process, and a method of using the polyalkylene terephthalate based polymer for textile applications, fiber applications, packaging applications, plastic applications, automotive applications, and electronic applications. The process may include a further step of converting a residue to obtain one or more monomer(s), polymer(s) or polymer product(s).

Also disclosed herein is a method for preparing a product including: providing a polyalkylene terephthalate based polymer; and preparing a textile, a fiber, a packaging, a plastic, an automotive part, or an electronic part from the polyalkylene terephthalate based polymer.

The present invention relates in a first aspect to a process for recovery of a polyalklene terephthalate based polymer from a polymeric material, the process comprising: (a) providing the polymeric material comprising polyalkylene terephthalate based polymer and providing a solvent system; (b) contacting the polymeric material with the solvent system at a temperature T, which is at least 1K, preferably at least 7K, below the boiling temperature of the solvent in the solvent system, which has the lowest boiling point, thereby obtaining a solvent system, which is enriched in dissolved polyalkylene terephthalate based polymer; (c) re-obtaining polyalkylene terephthalate based polymer from the solvent system obtained in (b); wherein the solvent system comprises at least N-butylpyrrolidone. A second aspect of the invention is directed to polyalkylene terephthalate based polymer obtained or obtainable from the process of the first aspect, and a third aspect relates to the use of the polyalkylene terephthalate based polymer of the second aspect for textile applications, fiber applications, packaging applications, plastic applications, automotive applications, electronic applications, preferably for the production of food packaging, beverage packaging, clothing, foot wear, wire, cable, wherein preferably for textile applications, fiber applications, packaging applications, plastic applications, more preferably for the production of food packaging, beverage packaging, clothing and foot wear. A fourth aspect of the invention is related to a method for preparing a product comprising (I) providing a polyalkylene terephthalate based polymer of the second aspect; and (II) preparing a textile, a fiber, a packaging, a plastic, an automotive part, an electronic part from the polyalkylene terephthalate based polymer provided in (I). A fifth aspect relates to a process comprising converting the re-obtained polyalkylene terephthalate based polymer obtained by the process according to the first aspect to obtain a polymer product. A sixth aspect is related to a process, preferably according to the first aspect, comprising a further step of converting a residue comprising at least one insoluble polymer selected from PP, PE, PA, natural polymer, viscose and linen obtainable by or obtained by the process according to the first aspect and/or a soluble polymer obtainable by or obtained by the process according to the first aspect, to obtain one or more monomer, polymer or polymer product.

The demand for polymeric materials has drastically increased over the last decades. However, the poor biodegradability has led to large amounts of plastic waste which is in Europe usually incinerated thereby losing valuable materials and generating huge CO₂ emissions. Even worse is landfill due to the poor biodegradability. Polymeric materials have been used extensively in the packaging sector, for example, in beverage packaging or food packaging. The vast majority of food and drink today is packaged within plastic bottles and containers, made from, for example, polymeric materials comprising polyethylene terephthalate (PET). PET is also a main component of clothing nowadays. As these materials typically have poor biodegradability and are also still valuable products, it is desirable for these plastics to be recovered and recycled.

Although recycling processes have been adopted to convert the waste materials into new production materials, there are still many problems associated with recycling and recovery of polymeric materials. Waste packaging often includes a mixture of different polymeric materials containing also, for example, colorants. The same applies also for textiles, which also comprise a high amount of colored polymeric materials. Therefore, in order to recycle polymeric materials, it is common to separate polymeric materials based on their color and/or their composition. However, this sorting process is labor intensive and/or requires the use of sorting machines.

Another approach for recovery of polymeric materials includes the dissolving of the polymeric material combined with precipitation. WO 2016/12755 A1 discloses an extraction of polyesters from packaging, wherein a first solvent is used for removal of colorants and a second solvent is used to dissolve the polyester. Chen et al. (Wenjun Chen, Yuechao Yang, Xue Lan, Baolong Zhang, Xiaogang Zhang and Tiancheng Mu in Green Chem., 2021, 23, 4065) describe a process for dissolution and accelerated alkaline hydrolysis of PET. WO 2022/221832 A1 describes a process for treatment of a polyethylene terephthalate (PET) stream, wherein a polar solvent is used for dissolution of the PET. The polar solvent is defined based on Hansen parameters, wherein a three dimensional rectangular Hansen room is defined by the parameter for energy from dispersion forces between molecules (SD) being in the range of from 15 to 20, the parameter for energy from dipolar intermolecular force between molecules (SP) being in the range of from 4 to 20 and the parameter for energy from hydrogen bonds between molecules (8H) being in the range of from 3 to 10. However, polar solvents were considered as solvents for PET according to said definition, which simply are not suited or are unable to dissolve PET, for example, glycerol triacetate, dimethyl succinate or ethyl levulinate. Thus, even knowing these disclosures, it is still unpredictable therefrom what solvents are precisely suitable to dissolve PET. Furthermore, with an eye on a re-use/re-cycling of the obtained PET, it must be considered detrimental if the PET is degraded during the dissolution/precipitation steps; however, the state of the art discloses lots of solvents, which, even if some kind of dissolution takes place, are not suited to recover non-degraded PET, meaning that even if some kind of polymeric material was re-obtained, it was degraded, for example, in view of reduced polymer chain lengths, reduced molecular weight etc.

The technical problem underlying the present invention was thus the provision of a process for recovery of a polyalkylene terephthalate based polymer, which overcomes these disadvantages, and which especially enables on one hand a precise selection of solvent(s) suitable to dissolve polyalkylene terephthalate based polymer, while on the other hand enabling recovery of non-degraded polyalkylene terephthalate based polymer.

The present invention thus relates in a first aspect to a process for recovery of a polyethylene terephthalate based polymer from a polymeric material, the process comprising:
(a) providing the polymeric material comprising polyalkylene terephthalate based polymer and providing a solvent system;
(b) contacting the polymeric material with the solvent system at a temperature T, which is at least 1K, preferably at least 7K, below the boiling temperature of the solvent in the solvent system, which has the lowest boiling point, thereby obtaining a solvent system, which is enriched in dissolved polyalkylene terephthalate based polymer;
(c) re-obtaining polyalkylene terephthalate based polymer from the solvent system obtained in (b);
wherein the solvent system comprises one or more solvent(s), wherein
(s. 1) the solvent system has Hansen solubility parameters with respect to
   energy from dispersion forces between molecules (δDₛₛ),
   energy from dipolar intermolecular force between molecules (δPₛₛ) and
   energy from hydrogen bonds between molecules (δHₛₛ),
   which fulfill equitation 1

(8.8)²≥4(δDₛₛ−20)²+(δPₛₛ−11.8)²+(δHₛₛ−4.5)² [equitation 1];
(s.2) each solvent of the solvent system has a boiling point at 1013 hPa of at least 160 °C; and
(s.3) solvents having a functional group selected from the group consisting of hydroxyl (OH), amino (NH₂), carboxyl (COOH), and thiol (SH) are excluded.

It was surprisingly found that all solvent systems having Hansen parameters fulfilling equitation 1 (s, 1) and fulfilling requirements (s.2) and (s.3) are able to dissolve polyalkylene terephthalate based polymer and do not have a negative impact on the re-obtained polyalkylene terephthalate based polymer, i.e. at least the number average molecular weight Mn of the re-obtained polyalkylene terephthalate based polymer is not detrimentally influenced—the Mn of the re-obtained polyalkylene terephthalate based polymer is always greater or at least equal to the Mn of the polyalkylene terephthalate based polymer comprised in the polymeric material initially provided. This offers the great advantage that the re-obtained polyalkylene terephthalate based polymer can directly be re-used. Obtaining an non-degraded polyalkylene terephthalate based polymer enables further processing of the polyalkylene terephthalate based polymer in a, preferably closed, loop recycling process. Preferably, the colored polymeric material, which preferably comes from textiles, fibers and/or packaging is thus recycled or recyclable into the same. Naturally, the re-obtained product can also be put to any further use without being restricted in this regard.

The boiling point of a solvent is understood as the boiling point of the solvent at the respective pressure. Any solvent system for which 4 (δDₛₛ−20)²+(δPₛₛ−11.8)²+(δHₛₛ−4.5)² is larger than (8.8)² (i.e. 77.44) is not suited to dissolve polyalkylene terephthalate based polymer properly and any solvent system for which 4 (δDₛₛ−20)²+(δPₛₛ−11.8)²+(δHₛₛ−4.5)² is equal to or smaller than (8.8)² (i.e. 77.44) is suitable for dissolving polyalkylene terephthalate based polymer. In case of two or more solvents being part of the solvent system, i.e. n solvents with n being an integer with n≥2 and i=1 . . . n, the Hansen solubility parameters of the resulting mixture with respect to each of δDₛₛ, δHₛₛ and δPₛₛ are calculated, knowing the percentage part of each solvent in the solvent system, as the weighted arithmetic mean from δDₛᵢ, δHₛᵢ and δPₛᵢ of each of the n solvents S(i). The Hansen parameters of solvents are to be found in in BIOVIA COSMOquick 2022.

It is understood that regarding (b), the expression “contacting the polymeric material with a solvent system at a temperature T, which is at least 1K, preferably at least 7K, below the boiling temperature of the solvent in the solvent system, which has the lowest boiling point” means that contacting the polymeric material is done with a solvent system at a temperature T, which is at least 1K, preferably at least 7K, below the boiling temperature of the solvent in the solvent system, which has the lowest boiling point of (all) solvents in the solvent system.

Considering the three-dimensional form given by equitation 1 in the three-dimensional Hansen space, a sphere is formed which has its center at δD_{c}=20, δP_{c}=11.8 and δH_{c}=4.5 and a radius r of 8.8. The doubling of the dispersion parameter value is required, according to Charles Hansen, for achieving a spherical form. A Hansen sphere, since there are no negative values possible for OH, can also be considered as a dome, i.e. a half-sphere. PET has Hansen parameters according to the 5th Edition 5.1.03 (2008) of the HANSEN Solubility Parameters in Practice (HSPiP) of δD=18.2, δP=6.4 and OH=6.6 and lies within the sphere but not at its center.

“Contacting” in step (b) preferably means that the polymeric material comprising polyalkylene terephthalate based polymer is at least partially immersed in the solvent system. Preferably, the polymeric material comprising polyalkylene terephthalate based polymer is at least partially immersed in the solvent system in that at least 60%, more preferably at least 70%, more preferably at least 80%, more preferably at least 90%, more preferably at least 95%, more preferably at least 99% of the polymeric material comprising polyalkylene terephthalate based polymer's surface are in contact with the solvent system, based on the total surface of the polymeric material comprising polyalkylene terephthalate based polymer being 100%.

“Enriched in dissolved polyalkylene terephthalate based polymer” means that at least 50 weight-5%, preferably at least 60 weight-%, more preferably at least 70 weight-%, more preferably at least 80 weight-%, more preferably at least 90 weight-%, more preferably at least 95 weight-%, of the polyalkylene terephthalate based polymer comprised in the polymeric material provided in (a) are dissolved in the solvent system, based on the total polyalkylene terephthalate based polymer comprised in the polymeric material provided in (a) being 100 weight-%, wherein dissolution is preferably determined upon visual inspection (by an observers eye(s)).

In some embodiments of the process, contacting in (b) is done at a temperature in the range of from 160 °C to the temperature T, which is at least 1K, preferably at least 7K, below the boiling temperature of the solvent in the solvent system, which has the lowest boiling point.

Optionally, the process comprises between (b) and (c) a heated filtration of the solvent system, which is enriched in dissolved polyalkylene terephthalate based polymer, obtained in (b), more preferably a heated filtration at a temperature in the range of T±20 °C, more preferably at a temperature in the range of T±10 °C. In heated filtration, the solution, filter, and funnel are heated, preferably heated so that each has temperature T±20 °C or T±10 °C. In some embodiments, it is preferred that the heated filtration is done at a pressure of ≥1bar, more preferably at a pressure in the range of from 1 bar to 30 bar, preferably in the range of from 1 to 10 bar, more preferably in the range of from 1 to 6 bar (heated pressure filtration). Other means and methods for the separation are known to the skilled person such as non-heated filtration or centrifugation. In some embodiments, the filter, preferably after the solvent system, which is enriched in dissolved polyalkylene terephthalate based polymer, has passed through it, is rinsed with solvent system for one or more times, preferably with a solvent system having the same composition as provided in (a) and used in (b), wherein the solvent system preferably has temperature T±20 °C or T±10 °C. In some embodiments, it is preferred that the solvent system, to which the cooling in (c.1) is applied, comprises the solvent system, which is enriched in dissolved polyalkylene terephthalate based polymer obtained in (b), which had been subjected to filtration and the rising charge(s).

In some embodiments of the process, at least 90 weight-%, preferably at least 95 weight-%, more preferably at least 98 weight-%, more preferably at least 99 weight-%, of the solvent system consist of two or more solvent(s), wherein the respective mixture fulfill(s) equitation 1.

In some embodiments of the process, at least 90 weight-%, preferably at least 95 weight-%, more preferably at least 98 weight-%, more preferably at least 99 weight-%, of the solvent system consist of one solvent, which fulfills equitation 1. In these cases, where the solvent system consists of only one solvent, the temperature T is a temperature at least 1K, preferably at least 7K, below the boiling temperature of said one solvent.

As described in more detail herein below, the process may also comprise a step (x) and substeps thereof, wherein a solvent system may be used. Said solvent system of (x) comprises one or more solvent(s) selected from the same groups as indicated herein above for the solvent system provided in (a), preferably the solvent system used in (x) is the same solvent system as provided in (a) and as used in (b). Thus, details disclosed herein regarding the solvent system equally apply for the solvent system provided in (a) and used in (b) and for the solvent system of (x).

In some embodiments of the process the one or more solvent(s) is/are selected from the group consisting of N,N-dimethylbenzamide, N,N-dimethylphenylacetamide, 1,4-benzoquinone, acetophenone, dimethyl terephthalate, 1,3,5-trimethoxybenzene, 2-phenylacetophenone, N-methylcaprolactam, methylbenzoate, methyl-4-methoxybenzoate, butylene carbonate, N-ethylpyrrolidone, benzophenone, di-benzyl malonate, N-ethyl-caprolactam, methyl 2-(5-oxotetrahydrofuran-3-yl)acetate (FAME), methyl 2-(5-oxotetrahydrofuran-2-yl)acetate, propiophenone, N-methoxypropyl-pyrrolidone, 1,4-cyclohexanedione, cyclohexane-carbonate, N-methoxyethyl-pyrrolidone, N, N-diethylphenylacetamide, phenyl acetate, 1-(2-hydroxyethyl) pyrrolidin-2-one acetate (HEPAc), N,N-diethylbenzamide, isopropyl-benzoate, cyclohexyl phenyl ketone, phenylacetic acid ethylester, phenylacetat,N-methyl-morpholine, benzyl-propionate, benzylacetate, Neopentyl-glycoldibenzoate, tetrahydrofurfuryl acetate, N-methyl-imidazole, benzyl butyrate, 2-pyrrolidone, 2-phenoxyethanol propionate, 2-phenoxyethyl isobutyrate, N, N-dipropylbenzamide, N,N-dimethylacetamide, N,N-diethylacetamide, dihydrolevoglucosenon (Cyrene), propylenecarbonate, caprolactone, dimethylisosorbide, N-butylpyrrolidone, t-butylpyrrolidone, methyl-1-methyl-5-oxopyrrolidine-3-carboxylate (MMOC), gamma-valerolactone (GVL), delta-valerolactone, gamma butyrolactone, methyl 5-(dimethylamino)-2-methyl-5-oxopentanoate (Rhodiasolv Polarclean), caprolactam, phen ethyl acetate, methyl phenylacetate, benzyl benzoate, N,N-dimethyllactamide (Agnique AMD 3L), and dimethyl sulfoxide (DMSO).

In some embodiments, the one or more solvent(s) is/are selected from the group consisting of dihydrolevoglucosenon (Cyrene), propylenecarbonate, caprolactone, dimethylisosorbide, N-butylpyrrolidone, t-butylpyrrolidone, methyl-1-methyl-5-oxopyrrolidine-3-carboxylate (MMOC), gamma-valerolactone (GVL), Delta-valerolactone, gamma butyrolactone, dimethylsulfoxide, methyl 5-(dimethylamino)-2-methyl-5-oxopentanoate (Rhodiasolv® Polarclean), caprolactam, phen ethyl acetate, methyl phenylacetate, benzyl benzoate, phenyl benzoate, methyl benzoate, propyl benzoate, and dimethyl sulfoxide (DMSO).

In some embodiments of the process, the one or more solvent(s) of the solvent system is/are selected from the group consisting of propylenecarbonate, N-butylpyrrolidone, t-butylpyrrolidone, methyl-1-methyl-5-oxopyrrolidine-3-carboxylate (MMOC), Delta-valerolactone, gamma butyrolactone, methyl 5-(dimethylamino)-2-methyl-5-oxopentanoate (Rhodiasolv@Polarclean), caprolactam, phenethyl acetate, methyl phenylacetate, benzyl benzoate, phenyl benzoate, methyl benzoate, propyl benzoate and GVL.

In some embodiments of the process, the one or more solvent(s) is/are selected from the group consisting of propylenecarbonate, N-butylpyrrolidone, t-butylpyrrolidone, methyl-1-methyl-5-oxopyrrolidine-3-carboxylate (MMOC), Delta-valerolactone, gamma butyrolactone, methyl 5-(dimethylamino)-2-methyl-5-oxopentanoate (Rhodiasolv® Polarclean), caprolactam, phen ethyl acetate, methyl phenylacetate, benzyl benzoate, phenyl benzoate, methyl benzoate, and propyl benzoate.

In some embodiments of the process, the one or more solvent(s) of the solvent system is/are selected from the group consisting of propylenecarbonate, N-butylpyrrolidone, t-butylpyrrolidone, methyl-1-methyl-5-oxopyrrolidine-3-carboxylate (MMOC), methyl 5-(dimethylamino)-2-methyl-5-oxopentanoate (Rhodiasolv® Polarclean), phenethyl acetate, and GVL.

In some embodiments of the process, the one or more solvent(s) is/are selected from the group consisting of propylenecarbonate, N-butylpyrrolidone, t-butylpyrrolidone, methyl-1-methyl-5-oxopyrrolidine-3-carboxylate (MMOC), methyl 5-(dimethylamino)-2-methyl-5-oxopentanoate (Rhodiasolv® Polarclean), and phen ethyl acetate.

In some embodiments of the process, the one or more solvent(s) is/are selected from the group consisting of gamma valerolactone (GVL), N-butylpyrrolidone (NBP), propylenecarbonate, acetophenone, dimethyl sulfoxide (DMSO), dihydrolevoglucosenon (Cyrene) and mixtures of two or more thereof. In some embodiments of the process, the one or more solvent(s) is/are selected from the group consisting of gamma valerolactone (GVL), N-butylpyrrolidone (NBP), propylenecarbonate, acetophenone, dimethyl sulfoxide (DMSO) and mixtures of two or more thereof. In some embodiments of the process, the one or more solvent(s) is/are selected from the group consisting of gamma valerolactone (GVL), N-butylpyrrolidone (NBP), propylenecarbonate, acetophenone and mixtures of two or more thereof. In some embodiments of the process, the one or more solvent(s) is/are selected from the group consisting of gamma valerolactone (GVL), N-butylpyrrolidone (NBP), acetophenone and mixtures of two or more thereof. In some embodiments of the process, the one or more solvent(s) is/are selected from the group consisting of gamma valerolactone (GVL), N-butylpyrrolidone (NBP) and mixtures of GVL and NBP.

In some embodiments of the process, the one or more solvent(s) is/are selected from the group consisting of N-butylpyrrolidone (NBP), propylenecarbonate, acetophenone, dimethyl sulfoxide (DMSO), dihydrolevoglucosenon (Cyrene) and mixtures of two or more thereof. In some embodiments of the process, the one or more solvent(s) is/are selected from the group consisting of N-butylpyrrolidone (NBP), propylenecarbonate, acetophenone, dimethyl sulfoxide (DMSO) and mixtures of two or more thereof. In some embodiments of the process, the one or more solvent(s) is/are selected from the group consisting of N-butylpyrrolidone (NBP), propylenecarbonate, acetophenone and mixtures of two or more thereof. In some embodiments of the process, the one or more solvent(s) is/are selected from the group consisting of N-butylpyrrolidone (NBP), acetophenone and mixtures of N-butylpyrrolidone (NBP) and acetophenone.

In some embodiments of the process, the one or more solvent(s) comprise at least gamma valerolactone (GVL), preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) are GVL, based on a total weight of the one or more solvent(s) being 100 weight-%, more preferably the one solvent is GVL. In some embodiments, contacting in (x) is done at a temperature T₁, which may be in the range of from 10 to <170 °C, wherein T₁ preferably may be in the range of from 140 to 160 °C, more preferably in the range of from 150 to 160 °C, or contacting in (x) is done at a temperature T, which may be in the range of from 65 to 45 K below the boiling point of the GVL, preferably in the range of from 55 to 45 K below the boiling point of the GVL. Further, in some embodiments, contacting in (b) is done at a temperature T, which may be in the range of from 160 °C to the temperature T, which is at least 7K below the boiling temperature of the GVL, preferably at a temperature T in the range of from 175 to 195 °C, more preferably in the range of from 180 to 190 °C or contacting in (b) is done at a temperature T, which may be in the range of from 30 to 10 K below the boiling point of the of the GVL, preferably in the range of from 25 to 15 K below the boiling point of the of the GVL. The contacting in (x) and/or, preferably and, in (b) is/are preferably done at a pressure in the range of from 800 to 1200 hPa. Preferably, the process is run at autogenous pressure, wherein the autogenous pressure may be higher than the ambient pressure of the surrounding area caused by the steam pressure of GVL at the temperature T at which the process is run. The skilled person can determine and/or adjust said autogenous pressure according to the steam pressure curve of GVL at a certain temperature T. Steam pressure curves of GVL are known to a person skilled in the art. The autogenous pressure may be lowered by purging, e.g. by a purging valve, preferably to a pressure between ambient pressure and lower 2000 hPa, preferably between 1200 hPa and 1800 hPa. Autogenous pressure is the pressure caused by the production system itself in a closed system, e.g. a pressure in the range from 800 to 3000 hPa.

In some embodiments of the process, the one or more solvent(s) comprise at least N-butylpyrrolidone, preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) are N-butylpyrrolidone, based on a total weight of the one or more solvent(s) being 100 weight-%, more preferably the one solvent is N-butylpyrrolidone. In some embodiments, contacting in (x) is done at a temperature T₁, which may be in the range of from 10 to <170 °C, wherein T₁ preferably may be in the range of from 140 to 160 °C, more preferably in the range of from 150 to 160 °C, or contacting in (x) is done at a temperature T, which may be in the range of from 101 to 81 K below the boiling point of the of the N-butylpyrrolidone, preferably in the range of from 91 to 81 K below the boiling point of the of the N-butylpyrrolidone. Further, In some embodiments, contacting in (b) is done at a temperature T, which may be in the range of from 160 °C to the temperature T, which is at least 7K below the boiling temperature of the N-butylpyrrolidone, preferably at a temperature T in the range of from 180 to 200 °C, more preferably in the range of from 185 to 195 °C or contacting in (b) is done at a temperature T, which may be in the range of from 61 to 41 K below the boiling point of the of the N-butylpyrrolidone, preferably in the range of from 56 to 46 K below the boiling point of the of the N-butylpyrrolidone. The contacting in (x) and/or, preferably and, in (b) is/are preferably done at a pressure in the range of from 800 to 1200 hPa. Preferably, the process is run at autogenous pressure, wherein the autogenous pressure may be higher than the ambient pressure of the surrounding area caused by the steam pressure of N-butylpyrrolidone at the temperature T at which the process is run. The skilled person can determine and/or adjust said autogenous pressure according to the steam pressure curve of N-butylpyrrolidone at a certain temperature T. Steam pressure curves of N-butylpyrrolidone are known to a person skilled in the art. The autogenous pressure may be lowered by purging, e.g. by a purging valve, preferably to a pressure between ambient pressure and lower 2000 hPa, preferably between 1200 hPa and 1800 hPa. Autogenous pressure is the pressure caused by the production system itself in a closed system, e.g. a pressure in the range from 800 to 3000 hPa.

In some embodiments of the process, the one or more solvent(s) comprise at least propylenecarbonate, preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) are propylenecarbonate, based on a total weight of the one or more solvent(s) being 100 weight-%, more preferably the one solvent is propylenecarbonate. In some embodiments, contacting in (x) is done at a temperature T₁, which may be in the range of from 10 to <170 °C, wherein T₁ preferably may be in the range of from 140 to 160 °C, more preferably in the range of from 150 to 160 °C or contacting in (x) is done at a temperature T, which may be in the range of from 102 to 82 K below the boiling point of the of the propylenecarbonate, preferably in the range of from 92 to 82 K below the boiling point of the of the propylenecarbonate. Further, In some embodiments, contacting in (b) is done at a temperature T, which may be in the range of from 160 °C to the temperature T, which is at least 7K below the boiling temperature of the propylenecarbonate, preferably at a temperature T in the range of from 185 to 205 °C, more preferably in the range of from 190 to 200 °C or contacting in (b) is done at a temperature T, which may be in the range of from 57 to 37 K below the boiling point of the of the propylenecarbonate, preferably in the range of from 52 to 42 K below the boiling point of the of the propylenecarbonate. The contacting in (x) and/or, preferably and, in (b) is/are preferably done at a pressure in the range of from 800 to 1200 hPa. Preferably, the process is run at autogenous pressure, wherein the autogenous pressure may be higher than the ambient pressure of the surrounding area caused by the steam pressure of propylenecarbonate at the temperature T at which the process is run. The skilled person can determine and/or adjust said autogenous pressure according to the steam pressure curve of propylenecarbonate at a certain temperature T. Steam pressure curves of propylenecarbonate are known to a person skilled in the art. The autogenous pressure may be lowered by purging, e.g. by a purging valve, preferably to a pressure between ambient pressure and lower 2000 hPa, preferably between 1200 hPa and 1800 hPa. Autogenous pressure is the pressure caused by the production system itself in a closed system, e.g. a pressure in the range from 800 to 3000 hPa.

In some embodiments of the process, the one or more solvent(s) comprise at least acetophenone, preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) are acetophenone, based on a total weight of the one or more solvent(s) being 100 weight-%, more preferably the one solvent is acetophenone. In some embodiments, contacting in (x) is done at a temperature T₁, which may be in the range of from 10 to <170 °C, wherein T₁ preferably may be in the range of from 140 to 160 °C, more preferably in the range of from 150 to 160 °C or contacting in (x) is done at a temperature T, which may be in the range of from 62 to 42 K below the boiling point of the of the acetophenone, preferably in the range of from 52 to 42 K below the boiling point of the of the acetophenone. Further, In some embodiments, contacting in (b) is done at a temperature T, which may be in the range of from 160 °C to the temperature T, which is at least 7K below the boiling temperature of the acetophenone, preferably at a temperature T in the range of from 165 to 185 °C, more preferably in the range of from 170 to 180 °C or contacting in (b) is done at a temperature T, which may be in the range of from 37 to 17 K below the boiling point of the of the acetophenone, preferably in the range of from 32 to 22 K below the boiling point of the of the acetophenone. The contacting in (x) and/or, preferably and, in (b) is/are preferably done at a pressure in the range of from 800 to 1200 hPa. Preferably, the process is run at autogenous pressure, wherein the autogenous pressure may be higher than the ambient pressure of the surrounding area caused by the steam pressure of acetophenone at the temperature T at which the process is run. The skilled person can determine and/or adjust said autogenous pressure according to the steam pressure curve of acetophenone at a certain temperature T. Steam pressure curves of acetophenone are known to a person skilled in the art. The autogenous pressure may be lowered by purging, e.g. by a purging valve, preferably to a pressure between ambient pressure and lower 2000 hPa, preferably between 1200 hPa and 1800 hPa. Autogenous pressure is the pressure caused by the production system itself in a closed system, e.g. a pressure in the range from 800 to 3000 hPa.

In some embodiments of the process, the one or more solvent(s) comprise at least dimethyl sulfoxide (DMSO), preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) are DMSO, based on a total weight of the one or more solvent(s) being 100 weight-%, more preferably the one solvent is DMSO. In some embodiments, contacting in (x) is done at a temperature T₁, which is in the range of from 10 to <170 °C, wherein T₁ is preferably in the range of from 140 to 160 °C, more preferably in the range of from 150 to 160 °C or contacting in (x) is done at a temperature T, which is in the range of from 49 to 29 K, preferably in the range of from 39 to 29 K below the boiling point of the of the DMSO. Further, In some embodiments, contacting in (b) is done at a temperature T, which may be in the range of from 160 °C to the temperature T, which is at least 1K below the boiling temperature of the DMSO, preferably at a temperature T in the range of from 170 to 188 °C below the boiling point of the of the DMSO, more preferably in the range of from 175 to 188 °C, or contacting in (b) is done at a temperature T, which may be in the range of from 19 to 1 K below the boiling point of the of the DMSO, preferably in the range of from 14 to 1 K below the boiling point of the of the DMSO. The contacting in (x) and/or, preferably and, in (b) is/are preferably done at a pressure in the range of from 800 to 1200 hPa. Preferably, the process is run at autogenous pressure, wherein the autogenous pressure may be higher than the ambient pressure of the surrounding area caused by the steam pressure of DMSO at the temperature T at which the process is run. The skilled person can determine and/or adjust said autogenous pressure according to the steam pressure curve of DMSO at a certain temperature T. Steam pressure curves of DMSO are known to a person skilled in the art. The autogenous pressure may be lowered by purging, e.g. by a purging valve, preferably to a pressure between ambient pressure and lower 2000 hPa, preferably between 1200 hPa and 1800 hPa. Autogenous pressure is the pressure caused by the production system itself in a closed system, e.g. a pressure in the range from 800 to 3000 hPa.

In some embodiments of the process, the one or more solvent(s) comprise at least dihydrolevoglucosenon (Cyrene), preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) are Cyrene, based on a total weight of the one or more solvent(s) being 100 weight-%, more preferably the one solvent is Cyrene. In some embodiments, contacting in (x) is done at a temperature T₁, which may be in the range of from 10 to <170 °C, wherein T₁ preferably may be in the range of from 140 to 160 °C, more preferably in the range of from 150 to 160 °C, or contacting in (x) is done at a temperature T, which may be in the range of from 86 to 66 K below the boiling point of the of the Cyrene, preferably in the range of from 76 to 66 K below the boiling point of the of the Cyrene. Further, In some embodiments, contacting in (b) is done at a temperature T, which may be in the range of from 160 °C to the temperature T, which is at least 7K below the boiling temperature of the Cyrene, preferably at a temperature T in the range of from 160 to 180 °C, more preferably in the range of from 160 to 170 °C or contacting in (b) is done at a temperature T, which may be in the range of from 66 to 46 K below the boiling point of the of the Cyrene, preferably in the range of from 66 to 56 K below the boiling point of the of the Cyrene. The contacting in (x) and/or, preferably and, in (b) is/are preferably done at a pressure in the range of from 800 to 1200 hPa. Preferably, the process is run at autogenous pressure, wherein the autogenous pressure may be higher than the ambient pressure of the surrounding area caused by the steam pressure of Cyrene at the temperature T at which the process is run. The skilled person can determine and/or adjust said autogenous pressure according to the steam pressure curve of Cyrene at a certain temperature T. Steam pressure curves of Cyrene are known to a person skilled in the art. The autogenous pressure may be lowered by purging, e.g. by a purging valve, preferably to a pressure between ambient pressure and lower 2000 hPa, preferably between 1200 hPa and 1800 hPa. Autogenous pressure is the pressure caused by the production system itself in a closed system, e.g. a pressure in the range from 800 to 3000 hPa.

Preferably, the re-obtained polyalkylene terephthalate based polymer of (c) has a number average molecular weight Mn, which is greater or at least equal to the Mn of the polyalkylene terephthalate based polymer comprised in the polymeric material provided in (a). Preferably, the re-obtained polyalkylene terephthalate based polymer of (c) has a dispersity Mw/Mn (Mass average molecular weight Mw divided by number average molecular weight Mn) in the range of from 70 to 95%, preferably in the range of from 75 to 90% of the dispersity Mw/Mn of the polyalkylene terephthalate based polymer comprised in the polymeric material provided in (a) (100%).

In some embodiments of the process, at least 50 weight-%, preferably at least 60 weight-%, more preferably at least 70 weight-%, more preferably at least 80 weight-%, more preferably at least 90 weight-%, more preferably at least 95 weight-%, more preferably at least 98 weight-% of the polymeric material comprising polyalkylene terephthalate based polymer are the polyalkylene terephthalate based polymer, based on the total weight of the polymeric material comprising polyalkylene terephthalate based polymer being 100 weight-%.

In some alternative embodiments of the process the polymeric material comprising polyalkylene terephthalate based polymer further comprises at least one polymer different from polyalkylene terephthalate based polymer and optionally at least one colorant. In some embodiments with at least one polymer different from polyalkylene terephthalate based polymer, the polymeric material comprising polyalkylene terephthalate based polymer is considered a polymer blend, wherein said at least one polymer different from polyalkylene terephthalate based polymer is in some embodiments selected from the group consisting of polypropylene (PP), polyethylene (PE), polyamide (PA), natural polymer such as cotton, viscose and/or linen and mixtures of two or more of these polymers. A “polymer blend” means a combination of at least one polymer with at least one further component, which is at least another polymer, these components combined with each other in any suitable way. For example, in case of at least two polymers, the polymers are intermixed, or one or more polymer(s) are embedded in and/or interwoven with one or more other polymer(s), or the polymers are aligned in separate layers, as well as hybrid forms of these combinations. PP, PE, PA and natural polymer such as cotton, viscose and/or linen are mostly not dissolved together with the polyalkylene terephthalate based polymer but rather remain undissolved. PA comprises preferably PA6 and PA66; however, in some embodiments the content of PA6 as further polymer is reduced and preferably, the polymeric material comprising polyalkylene terephthalate based polymer provided in (a) does comprise less than 10 weight-% PA6. In some embodiments, the polymeric material derives from textiles such as clothing, wherein the textiles are preferably subjected to a sorting process before the polymeric material is subjected to a method according to the present invention. A sorting process preferably comprises one or more NIR sorting steps, wherein textiles are analysed by near-infrared (NIR) spectroscopy and, based on the analytic result, sorted based on their composition. Thus, the polymeric material subjected to the method according to the present invention is preferably a presorted, more preferably an NIR presorted, textile. The textile has preferably underwent a size reduction, more preferably a cutting and/or shredding step. Thus, the polymeric material subjected to the method according to the present invention is preferably a pre-sorted, more preferably an NIR presorted, and/or size reduced, more preferably shredded, textile. In some embodiments, the polymeric material subjected to the method according to the present invention is preferably a pre-sorted, more preferably an NIR presorted, and/or size reduced, more preferably shredded, textile, which has a content of PA6 of less than 10 weight-%, more preferably of less than 5 weight-%, more preferably of less than 4 weight-%, more preferably of less than 3 weight-%, more preferably of less than 2 weight-%, more preferably of less than 1 weight-%, based on the total weight of the polymeric material being 100 weight-%. Lowering the content of PA in the textile may provide an improved quality of the obtained polyester, in particular of the polyalkylene terephthalate based polymer.

If present in the polymeric material comprising polyalkylene terephthalate based polymer, the solvent system obtained in (b), which is enriched in dissolved polyalkylene terephthalate based polymer is separated from the residue, which comprises at least one of PP, PE, PA natural polymer, viscose and linen. All polymers not soluble together with the polyalkylene terephthalate based polymer, preferably all polymers not soluble together with the polyalkylene terephthalate based polymer in a solvent system as defined above under the conditions of step (b) as defined above, are called herein “insoluble polymers”. Thus, (b), if at least one insoluble polymer is present, preferably comprises
(b.1) contacting the polymeric material with the solvent system at a temperature T, which is at least 1K, preferably at least 7K, below the boiling temperature of the solvent in the solvent system, which has the lowest boiling point, thereby obtaining a solvent system, which is enriched in dissolved polyalkylene terephthalate based polymer and a residue, preferably comprising at least one insoluble polymer selected from PP, PE, PA, natural polymer, viscose and linen;
(b.2) optionally separation of the solvent system, which is enriched in dissolved polyalkylene terephthalate based polymer from the residue, thereby obtaining an insoluble polymer-free solvent system enriched in dissolved polyalkylene terephthalate based polymer and a residue, preferably comprising at least one insoluble polymer selected from PP, PE, PA, natural polymer, viscose and linen,
wherein the separation is preferably done by heated filtration, preferably at a temperature in the range of T±20 °C, more preferably at a temperature in the range of T±10 °C. In heated filtration, the solution, filter, and funnel are heated, preferably heated so that each has temperature T±20 °C or T±10 °C. In some embodiments, it is preferred that the heated filtration is done under a pressure of ≥1 bar, more preferably at a pressure in the range of from 1 bar to 30 bar, preferably in the range of from 1 to 10 bar, more preferably in the range of from 1 to 6 bar (heated pressure filtration). Other means and methods for the separation are known to the skilled person such as non-heated filtration. In some embodiments, the filter and the residue comprising at least one insoluble polymer (which is retained on the filter), preferably after the solvent system, which is enriched in dissolved polyalkylene terephthalate based polymer, has passed through the filter, is rinsed with solvent system for one or more times, preferably with a solvent system having the same composition as provided in (a) and used in (b), wherein the solvent system preferably has temperature T±20 °C or T±10 °C. In some embodiments, it is preferred that the solvent system, to which the cooling in (c.1) is applied, comprises the solvent system, which is enriched in dissolved polyalkylene terephthalate based polymer, which had been subjected to filtration and the rising charge(s).

In some embodiments of the process, (b) or (b.1) is done in counter current mode. For example, if the contacting of step (b) or (b.1) is done within a vessel, the solvent system enters the vessel from one direction (either side or top/bottom) and the colored polymeric material enters the vessel from an another, preferably an opposite, direction. In a preferred constellation wherein a vertically arranged vessel is used, the solvent system enters the vessel from the bottom and the colored polymeric material enters the vessel from the top. In some embodiments of the process, (b) or (b.1) is conducted under mechanical intermixing, wherein mechanical intermixing preferably comprises one or more methods selected from stirring, blending, and ultra sound.

In some embodiments of the process, at least 40 weight-%, more preferably at least 50 weight-%, more preferably at least 60 weight-%, more preferably at least 70 weight-%, more preferably at least 80 weight-%, more preferably at least 90 weight-% of the polymeric material comprising polyalkylene terephthalate based polymer are polyalkylene terephthalate based polymer, and at the outmost 60 weight-%, more preferably at the outmost 50 weight-%, more preferably at the outmost 40 weight-%, more preferably at the outmost 30 weight-%, more preferably at the outmost 20 weight-%, more preferably at the outmost 10 weight-% of the polymeric material comprising polyalkylene terephthalate based polymer are at least one polymer different from polyalkylene terephthalate based polymer and optionally at least one colorant, each based on the total weight of the polymeric material comprising polyalkylene terephthalate based polymer being 100 weight-%.

### Polyalkylene Terephthalate Based Polymer

The “polyalkylene terephthalate based polymer” consists of either oxyethylen units or oxybutylen units and oxyterephthaloyl units, wherein in case of oxyethylen units, in the range of from 0 to 5 mol-% of the oxyterephthaloyl units are replaced by oxyisophthaloyl units and/or in the range of from 0 to 49 mol-% of the oxyethylen units are replaced by oxymethylene cyclohexylene methylene units. Preferably, the polyalkylene terephthalate based polymer is selected from the group consisting of PET (polyethylene terephthalate), PETG (poly(ethylene terephthalate-co-1,4-cyclohexylene dimethylene terephthalate)), PETI (poly(ethylene terephthalate-co-isophthalate)), PBT (polybutylene terephthalate), and mixtures of two or more of these polymers, or the polyalkylene terephthalate based polymer is selected from the group consisting of PET (polyethylene terephthalate), PETI (poly(ethylene terephthalate-co-isophthalate)), PBT (polybutylene terephthalate), and mixtures of two or three of these polymers. In some embodiments, the polyalkylene terephthalate based polymer comprises at least 80 weight-%, more preferably at least 85 weight-%, more preferably at least 90 weight-%, more preferably at least 95 weight-%, more preferably at least 96 weight-%, more preferably at least 97 weight-%, of PET based on the total weight of the polyalkylene terephthalate based polymer being 100 weight-% and/or, preferably and, at the outmost 20 weight-%, more preferably at the outmost 15 weight-%, more preferably at the outmost 10 weight-%, more preferably at the outmost 5 weight-%, more preferably at the outmost 4 weight-%, more preferably at the outmost 3 weight-%, more preferably at the outmost 2 weight-%, more preferably at the outmost 1 weight-%, of PETI, based on the total weight of the polyalkylene terephthalate based polymer being 100 weight-%.

In some embodiments, the “polyalkylene terephthalate based polymer” comprises or is a polyester based on 1,4-butanediol or 1,2-ethandiol, more preferably a polyester selected from the group consisting of a polymer based on 1,4-butanediol and terephthalic acid (polybutylene terephthalate, PBT), a polymer based on 1,2-ethanediol and terephthalic acid (polyethylene terephthalate, PET), a copolymer of 1,4-butanediol, adipic acid and terephthalic acid (polybutylenadipat-terephthalat, PBAT), a polymer of 1,2-ethanediol and 2,5-furandicarboxylic acid (polyethylene furanoate, PEF) and mixtures of two or more of these (co) polymers.

More preferably, the “polyalkylene terephthalate based polymer” comprises at least PET and/or PBT, more preferably the polyester is PET or PBT or a mixture of PET and PBT.

More preferably the polyalkylene terephthalate based polymer comprises or is PET.

In some embodiments of the process, polymeric material comprising polyalkylene terephthalate based polymer and solvent system are contacted in a mass-based ratio solventsystem:polymeric material in the range of from 1:1 to 100:1, preferably in the range of from 1:1 to 50:1, more preferably in the range of from 1:1 to 20:1, more preferably in the range of from 1:1 to 10:1.

In some embodiments of the process, (b), (x) and (c), preferably (a), (b), (x) and (c) are done at a pressure in the range of from 800 to 200,000 hPa; the same applies for all substeps of (b), (x) and (c) described above and in the following. In some embodiments, (b), (x) and/or (c), preferably (a), (b), (x) and (c) are done at a pressure in the range of from 800 to 1200 hPa.; the same applies for all substeps of (b), (x) and (c) described above and in the following.

In some embodiments, (b), if at least one insoluble polymer is present, comprises
(b.3) optionally washing the residue comprising at least one insoluble polymer selected from PP, PE, PA, natural polymer, viscose and linen, thereby obtaining a washed residue;
(b.4) optionally drying the washed residue obtained in (b.3).

Washing in optional step (b.3) is preferably done with a solvent system having features (s. 1), (s.2) and (s.3) as defined above, preferably with a solvent system comprising one or more of the solvent(s) of any one of the groups defined above. In some embodiments, a subsequent washing of the washed residue is done with a solvent selected from the group consisting of methanol, ethanol, propanol, isopropanol, acetonitrile, ethyl acetate, acetone, water or a mixture of two or more of these solvents or with a solvent selected from the group consisting of methanol, ethanol, propanol, isopropanol, acetonitrile, ethyl acetate, acetone, water, GVL, or a mixture of two or more of these solvents. Drying in optional step (b.4) is preferably done under one or more conditions selected from the group consisting of a pressure in the range of from 1 to 1013 mbar; a temperature in the range of from 50 to 210 °C, preferably in the range of from 60 to 180 °C, more preferably in the range of from 80 to 160 °C; drying time in the range of from 30 minutes to 24 hours; drying in an atmosphere comprising nitrogen, preferably in an atmosphere having at least 90 volume-%, more preferably 95 volume-%, more preferably at least 98 volume-% nitrogen. Drying is done by one or more methods selected from the group consisting of contact drying, convection drying and radiation drying.

In some embodiments of the process, (c) comprises:
(c.1) optionally after heated filtration, cooling the solvent system obtained in (b), which is enriched in dissolved polyalkylene terephthalate based polymer compared to the solvent system provided in (a), or the insoluble polymer-free solvent system enriched in dissolved polyalkylene terephthalate based polymer obtained in (b.2) to a temperature below 160 °C, preferably below 150 °C, more preferably below 140 °C, more preferably below 120 °C;
(c.2) obtaining a precipitated polyalkylene terephthalate based polymer and a solvent system, which is depleted in dissolved polyalkylene terephthalate based polymer.

The temperature to which the cooling is done is preferably a temperature below 160 °C, preferably below 150 °C, more preferably below 140 °C, more preferably below 120 °C and, in each case, above 0 °C, preferably above 5 °C, more preferably above 10 °C.

“Depleted in dissolved polyalkylene terephthalate based polymer” means that at least 50 weight-%, preferably at least 60 weight-%, more preferably at least 70 weight-%, more preferably at least 80 weight-%, more preferably at least 90 weight-%, more preferably at least 95 weight-%, of the polyalkylene terephthalate based polymer dissolved in the solvent system, based on the total polyalkylene terephthalate based polymer, which was initially comprised in the polymeric material provided in (a) being 100 weight-%, are no longer dissolved in the solvent system but rather precipitated.

In some embodiments of the process, cooling in (c.1) is done without addition of anti-solvents. Cooling is done by any suitable method, for example, by letting the solvent obtained in (c.1) stand under ambient conditions (1013 hPa and room temperature 20-25 °C), preferably with a cooling rate in the range of from 20 to 80 K/h, or by applying cooling means such as slow cooling, preferably in a crystallizer, preferably with a cooling rate in the range of from 3 to 25 K/h, In some embodiments with a cooling rate in the range of from 3 to 60 K/h, fast cooling, preferably with a cooling rate>100 K/h, dripping into solvent, which has a temperature below 30 °C, wherein the solvent for dripping is the same or different as the solvent(s) of the solvent system provided in (a) but is in any case also a solvent, which Hansen parameters fulfill equitation 1. An “antisolvent” is a solvent having a solubility regarding the polyalkylene terephthalate based polymer<1 g/kg at a temperature in the range of from 20 to 25 °C.

In cases where the polymeric material comprising polyalkylene terephthalate based polymer furthe comprises at least one colorant, the solvent system obtained in (b), which is enriched in dissolved polyalkylene terephthalate based polymer is also enriched in colorant. The colorant is preferably selected from the group consisting of dye and optical brightener and mixtures of dye and optical brightener.

In some embodiments, the process comprises
(d) separating the precipitated polyalkylene terephthalate based polymer obtained in (c) or (c.2) from the solvent system, which is depleted in dissolved polyalkylene terephthalate based polymer, thereby obtaining a precipitated polyalkylene terephthalate based polymer and the solvent system, which is depleted in dissolved polyalkylene terephthalate based polymer.

The separation in (d) is done by methods and means known to the skilled person, especially solid-liquid separation methods such as filtration, for example, heated pressure filtration, sedimentation or centrifugation (see Handbuch der mechanischen Fest-Flüssig-Trennung Taschenbuch-29. Apr. 2004 von Klaus Luckert (Herausgeber)). Colorants remain at least partially in the separated solvent system obtained in (d).

In some embodiments, the process comprises
(e) optionally washing the precipitated polyalkylene terephthalate based polymer obtained in (d);
(f) drying the precipitated polyalkylene terephthalate based polymer obtained in (d) or the washed precipitated polyalkylene terephthalate based polymer obtained in (e).

Washing in optional step (e) is preferably done with a solvent system having features (s.1), (s.2) and (s.3) as defined above, preferably with a solvent system comprising one or more of the solvent(s) of any one of the groups defined above. In some embodiments, washing is done with a solvent selected from the group consisting of methanol, ethanol, propanol, isopropanol, acetonitrile, ethyl acetate, acetone, water or a mixture of two or more of these solvents. In some embodiments, the washing in optional step (e) is done with a solvent selected from the group consisting of methanol, ethanol, propanol, isopropanol, acetonitrile, ethyl acetate, acetone, water, GVL, or a mixture of two or more of these solvents. Drying in step (f) is preferably done under one or more conditions selected from the group consisting of a pressure in the range of from 1 to 1013 mbar; a temperature in the range of from 50 to 210 °C, preferably in the range of from 60 to 180 °C, more preferably in the range of from 80 to 160 °C; drying time in the range of from 30 minutes to 24 hours; drying in an atmosphere comprising nitrogen, preferably in an atmosphere having at least 90 volume-%, more preferably 95 volume-%, more preferably at least 98 volume-% nitrogen. Drying is done by one or more methods selected from the group consisting of contact drying, convection drying and radiation drying.

In some embodiments of the process, (d), (e) and (f) are done at a pressure in the range of from 800 to 200,000 hPa.

A “colorant” is a substance that cause the change of color impression of polymeric material. This comprises dyes, which absorb wavelength intervals of visible light (400 to 780 nm) and optical brighteners, which amplify the light emission of a polymeric material through UV light adsorption and emittance of visible light (through fluorescence), i.e. an optical brightener converts radiation that is not visible to the human eye (<400 nm) into visible fluorescence radiation of the blue-red spectral range (400 to 600 nm). Colorants usable or used for changing the color impression of polymeric materials are known to the skilled person. In the context of the present invention, the term “dye” means any kind of dye such as dye, pigment, dispersion, wherein a dye is, for example, one or more selected from the group consisting of acid dye, basic dye, direct dye, disperse dye, azoic dye, food dye, solvent dye, organic dye, inorganic dye, organic pigment, inorganic pigment, disperse ink, reactive ink, oxidation dye, reactive dye, sulfur dye, mordant dye and vat dye. The term “optical brightener” comprises optical brightening agents, fluorescent brightening agents, and fluorescent whitening agents.

Overviews of colorants for polymeric materials can be found, for example, in “Dyes and Pigments” Metin Açikyildiz, Kübra Günes, Ahmet Gürses Springer, 2016 (ISBN: 10:3319338900); Industrial Organic Pigments-Klaus Hunger, Thomas Heber, Martin U. Schmidt, Friedrich Reisinger, Stefan Wanne Wiley-VCH, 4^{th} edition, 2018 (ISBN: 978-3-527-32608-2); Chemistry and Technology of Natural and Synthetic Dyes and Pigments-Ashis Kumar Samanta, Nasser Awwad, IntechOpen, 2020 (ISBN: 9781789859980, 9781789859973, 9781839687587); Encyclopedia of Color, Dyes, Pigments—Volume 1, Gerhard Pfaff, de Gruyter, 2021 (ISBN: 311058588X); Heinrich Zollinger: Color Chemistry: Syntheses, Properties, and Applications of Organic Dyes and Pigments. 3^{rd} edition. WILEY-VCH Verlag, Weinheim 2003 (ISBN: 3-906390-23-3); Klaus Hunger (Ed.): Industrial Dyes: Chemistry, Properties, Applications. WILEY-VCH Verlag, Weinheim 2003 (ISBN: 3-662-01950-7); Hermann Rath: Lehrbuch der Textilchemie. einschl. der textilchemischen Technologie. 2nd edition. Springer-Verlag, Berlin, Heidelberg 1963 (ISBN: 978-3-662-00065-6); Wilfried Kratzert, Rasmus Peichert: Farbstoffe. Quelle & Meyer, Heidelberg 1981 (ISBN: 3-494-01021-8); Ullmann's Encyclopedia of industrial chemistry, Wiley-VCH, 2000, sections “dyes and pigments” and “dyes, general survey” (ISBN: 9783527303854).

“Depleted in colorant” means that at least 50 weight-%, preferably at least 60 weight-%, more preferably at least 70 weight-%, more preferably at least 80 weight-%, more preferably at least 90 weight-%, more preferably at least 95 weight-%, of the colorant comprised in the colored polymeric material provided in (a), more preferably of the colorant comprised in the polyalkylene terephthalate based polymer contained therein, are removed from the polymeric material, more preferably from the polyalkylene terephthalate based polymer contained therein. “Enriched in colorant” means that at least 50 weight-%, preferably at least 60 weight-%, more preferably at least 70 weight-%, more preferably at least 80 weight-%, more preferably at least 90 weight-%, more preferably at least 95 weight-%, of the colorant comprised in the material provided in (a) more preferably of the colorant comprised in the polyalkylene terephthalate based polymer contained therein, are dissolved in the solvent system.

The precipitated polyalkylene terephthalate based polymer obtained in (c.2) and/or (e), preferably in (e), is depleted of colorant since the colorant remains dissolved in the solvent system, wherein depleted in colorant regarding the polyalkylene terephthalate based polymer means that compared to the polymeric material comprising polyalkylene terephthalate based polymer provided in (a), change in that:
the absolute value of a* changes, preferably by at least 0.2; and/or, preferably and,
the absolute value of b* changes, preferably by at least 0.2; and/or, preferably and,
the L* value increases, preferably by at least 4,
each compared to the L*a*b* values of the colored polymeric material provided in (a), wherein L*a*b* values are determined according to DIN 5033 and DIN EN ISO 11664-1.6.

The expression “irrespective of the color” means that, even if analytics are normally done for materials of each color separately, the definitions given above apply for single-colored polymeric materials, but also for polymeric materials having a plurality of colors and mixtures of pieces of polymeric materials, wherein each piece has its own color or its own color mix.

The condition of being “depleted in colorant”, which is expressed above based on quantitative L*a*b* values is also identifiable visually by the eye: The polymeric material comprising polyalkylene terephthalate based polymer provided in (a) has a certain color, wherein the polyalkylene terephthalate based polymer obtained, preferably obtained from (c.2) or (e) or (f) as described above is lighter and whiter respectively. This applies especially for all colorants not being optical brighteners. Depleted in colorant regarding the polyalkylene terephthalate based polymer obtained means, especially with respect to optical brighteners being the colorant, that the intensity of emitted fluorescence radiation (emission), preferably in the range of from 400 to 600 nm, is reduced for the polyalkylene terephthalate based polymer obtained in (c.2) when irradiated with light with a wavelength in the range of from 250 to 400 nm compared to the intensity of emitted fluorescence radiation (emission), preferably in the range of from 400-600 nm, of the polymeric material comprising polyalkylene terephthalate based polymer provided in (a).

Methods for determination of the intensity of emitted fluorescence radiation are known to the skilled person, for example, the determination can be made visually by using an UV lamp, by fluorescence determination or determination of quantum yield.

In some embodiments, the process, if at least one soluble polymer different from polyalkylene terephthalate is present in the polymeric material, comprises:
(x) contacting the polymeric material with a solvent system at a temperature T₁ of <170 °C, thereby obtaining a solvent system, which is enriched in dissolved further polymer, and a residue of the polymeric material, which is depleted of said further polymer, and comprises the polyalkylene terephthalate;
wherein step (x) is preferably carried out prior to step (b).

In some embodiments of the process, the at least one soluble polymer comprises, preferably is, an elastic fiber.

Preferably, the elastic fiber comprises, preferably consists of one or more polyurethane based elastic fiber(s) and/or one or more polyester based elastic fiber(s), more preferably the elastic fiber comprises, preferably consists of one or more polyurethane based elastic fiber(s), wherein more preferably at least 40 weight-%, more preferably at least 45 weight-%, more preferably at least 50 weight-%, more preferably at least 55 weight-%, more preferably at least 60 weight-%, more preferably at least 65 weight-%, more preferably at least 70 weight-%, more preferably at least 75 weight-%, more preferably at least 80 weight-%, more preferably at least 85 weight-%, more preferably at least 90 weight-%, more preferably at least 95 weight-%, more preferably at least 99.9 weight-%, of the elastic fiber are polyurethane based elastic fiber(s), each based on the total weight of the elastic fiber being 100 weight-%.

The polyurethane based elastic fiber(s) is/are preferably (block)copolymers based on polyurethane. A (block)copolymer based on polyurethane is preferably a (block)copolymer of polyurethane and one or more polyether(s) selected from the group consisting of polyethylene glycol, polytetrahydrofurane, a copolymer of 2-methyl-tetrahydrofurane and tetrahydrofurane, and a copolymer of 3-methyl-tetrahydrofurane and tetrahydrofurane, wherein the (block)copolymer based on polyurethane is more preferably a (block)copolymer of polyurethane and polyethylene glycol or a (block)copolymer of polyurethane and polytetrahydrofurane, wherein more preferably in each of these (block)copolymers of polyurethane, the polyurethane content is at least 85 weight-%, based on the total weight of the (block)copolymer being 100 weight-%. The expression “(block)copolymer” means copolymer and blockcopolymer, wherein blockcopolymer is preferred. (Block) copolymers of polyurethane with one or more polyether(s) selected from the group consisting of polyethylene glycol, polytetrahydrofurane, a copolymer of 2-methyl-tetrahydrofurane and tetrahydrofurane, a copolymer of 3-methyl-tetrahydrofurane and tetrahydrofurane, especially when the polyurethane content is at least 85 weight-% based on the total weight of the (block)copolymer being 100 weight-%, are also called by generic names such as “spandex”, “elastan (e)”, “elastano”, “elastam”, “elastaan” or “lycra”. Brand names include also “Lycra”, “Elaspan”, “Acepora”, “Creora”, “INVIYA”, “ROICA”, “Dorlastan”, “Linel” and “ESPA”. A polyester based elastic fiber is preferably a poly(trimethylene terephthalate) (PTT) copolymer, wherein the poly(trimethylene terephthalate) copolymer is more preferably selected from the group of copolyesters synthesized from 2 or more reactants, each reactant having two functional groups capable of forming ester groups. For example, a poly(trimethylene terephthalate) copolymer may be prepared by reacting 1,3-propanediol and terephthalic acid, and optionally one or more comonomers selected from the group consisting of linear aliphatic dicarboxylic acids having 4 to 12 carbon atoms, cyclic aliphatic dicarboxylic acids having 4 to 12 carbon atoms, branched aliphatic dicarboxylic acids having 4 to 12 carbon atoms (such as butanedioic acid, pentanedioic acid, hexanedioic acid, azelaic acid, sebacic acid, dodecanedioic acid, 1,4-cyclohexanedicarboxylic acid, or ester-forming equivalents thereof), aromatic dicarboxylic acids other than terephthalic acid having 8 to 12 carbon atoms (such as phthalic acid, isophthalic acid or 2,6-naphthalenedicarboxylic acid); linear diols other than 1,3-propanediol having 2 to 8 carbon atoms, cyclic diols having 2 to 8 carbon atoms, and branched aliphatic diols having 2 to 8 carbon atoms (such as ethanediol, 1,2-propanediol, 1,4-butanediol, hexamethylene glycol, 3-methyl-1,5-pentanediol, 2,2-dimethyl-1,3-propanediol, 2-methyl-1,3-propanediol, cyclohexane dimethanol or 1,4-cyclohexanediol), aliphatic ether glycols having 4 to 10 carbon atoms and aromatic ether glycols having 4 to 10 carbon atoms (such as hydroquinone bis(2-hydroxyethyl) ether). Alternatively, a poly(trimethylene terephthalate) copolymer may be prepared from a poly(ethylene ether) glycol having a molecular weight below 460 g/mol, such as diethylene ether glycol, methoxypolyalkylene glycol, diethylene glycol, and polyethylene glycol. The comonomer is present in the copolymer in the range of from 0.5 to 30 mol %, preferably in the range of from 0.5 to 20 mol %. A generic name for a poly(trimethylene terephthalate) (PTT) copolymer is “Sorona”, wherein Sorona is in some embodiments a copolymer of 1,3-propane diol (preferably obtained by formation) and terephthalic acid (TPA) or dimethyl terephthalate (DMT), wherein preferably in the range of from 20 to 50 weight-%, more preferably in the range of from 30 to 40 weight-% of the copolymer are based on 1,3-propane diol, more preferably 1,3-propane diol obtained from renewable resources.

In some embodiments of the process, (x) comprises
(x.1) contacting the polymeric material with a solvent system at a temperature T₁ of <170 °C, thereby obtaining a solvent system, which is enriched in dissolved soluble polymer, and a residue of the polymeric material, wherein said residue is depleted of said soluble polymer, and said residue comprises the polyalkylene terephthalate;
(x.2) separating the solvent system, which is enriched in dissolved soluble polymer obtained in (x.1) from the residue, preferably by a physical separation method, thereby obtaining a separated solvent system, which is enriched in dissolved soluble polymer, compared to the solvent system used for contacting in (x. 1) and a residue of the polymeric material, wherein said residue is depleted of said soluble polymer, and said residue comprises the polyalkylene terephthalate; and
(x.3) optionally separating the soluble polymer from the separated solvent system obtained in (x.2), thereby obtaining a separated fraction comprising the soluble polymer.

In some embodiments of the process, T₁ is a temperature≤165 °C, more preferably ≤160 °C. Preferably, T₁ is a temperature in the range of from 110 to <170 °C, preferably a temperature in the range of from 110 to 165 °C, more preferably a temperature in the range of from 110 to 160 °C. In cases where the polymeric material comprising polyalkylene terephthalate based polymer further comprises at least one colorant, the solvent system obtained in (x.1), which is enriched in dissolved soluble polymer is also enriched in colorant. The colorant is preferably selected from the group consisting of dye and optical brightener and mixtures of dye and optical brightener. If step (x) or (x.1) are carried out, at least a part of colorant is already removed from the residue of the polymeric material, which is depleted of soluble polymer, and comprises the polyalkylene terephthalate obtained in (x) or (x.1). Consequently, none or at least less colorant needs to be removed in step (b), compared to a process without step (x) or (x.1).

Separation of the soluble polymer, if present in the polymeric material, and optionally of colorant from the separated fraction comprising the soluble polymer obtained in (x.3) is done by, for example, distillation, wherein the solvent system is removed and the remaining residue comprising soluble polymer (or a remainder thereof) and optionally colorant is put to a further use and the recovered solvent system is preferably recycled into the process. “Remainder” of soluble polymer means that the soluble polymer might be recovered undamaged and/or in at least partially depolymerized form.

In some embodiments of the process, (x) comprises
(x.4) washing the residue of the polymeric material obtained in (x.2) with a washing solvent, thereby obtaining a washed residue, which is depleted of said further polymer, and comprises the polyalkylene terephthalate;
(x.5) optionally drying the washed residue comprises the polyalkylene terephthalate obtained in (x.4), thereby obtaining a dried and washed residue comprising the polyalkylene terephthalate.

In some embodiments of the process, contacting in (x) or (x.1) is done in a mass-based ratio solventsystem:polymeric material in the range of from 1:1 to 100:1, preferably in the range of from 1:1 to 50:1, more preferably in the range of from 1:1 to 20:1, more preferably in the range of from 1:1 to 10:1.

In some embodiments of the process, (x) or one or more of (x.1) to (x.5), preferably (x.1) to (x.5) are done at a pressure in the range of from 800 to 200,000 hPa.

In some embodiments of the process, the solvent system used for contacting in (x) or (x.1) is as defined in any one of embodiments 1 to 13, wherein preferably, the same solvent as provided in (a) and used for contacting in (b) is used for contacting in (x) or (x.1).

In some embodiments of the process, the polymeric material contacted with solvent system in step (b) is the separated residue of the polymeric material, which is depleted of soluble polymer, and comprises the polyalkylene terephthalate obtained in (x.2) and/or the separated fraction comprising the soluble polymer obtained in (x.3) and/or the washed residue which comprises the polyalkylene terephthalate obtained in (x.4) and/or the dried washed residue obtained in (x.5).

In some embodiments, the process comprises recycling separated solvent system obtained in one or more of the process steps described above back into the process, optionally after one or more work-up step(s).

### 2^{nd} Aspect—Product-by-Process

The present invention also relates in a second aspect to a polyethylene terephthalate based polymer obtained or obtainable from the process of the first aspect, preferably obtained or obtainable from step (d), (e), (f) or (x), more preferably from step (f). All details and embodiments disclosed above in the section related to the first aspect also apply for the second aspect.

### 3^{rd} Aspect—Use

The present invention also relates in a third aspect to the use of the polyethylene terephthalate based polymer of the second aspect for textile applications, fiber applications, packaging applications, plastic applications, automotive applications, electronic applications, preferably for the production of food packaging, beverage packaging, clothing, foot wear, wire, cable, wherein preferably for textile applications, fiber applications, packaging applications, plastic applications, more preferably for the production of food packaging, beverage packaging, clothing and foot wear. All details and embodiments disclosed above in the section related to the first aspect also apply for the third aspect.

Preferably, the polyalkylene terephthalate based polymer of the second aspect is used for:
a part of a car; preferably cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, A, B, C or D pillar cover, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, or coating;
a cloth; preferably shirt, trousers, pullover, boot, shoe, shoe sole, tight or jacket;
an electrical part; preferably electrical or electronic passive or active component, circuit board, printed circuit board, housing component, foil, line, switch, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), or spring tongue;
a consumer, agricultural product or pharmaceutical product; preferably tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, or pesticide;
a packaging for the food industry; preferably mono- or multi-layer blown film, cast film (mono- or multi-layer), biaxially stretched film, or laminating film; or
a part of a construction; preferably a rotor blade, insulating material, frame, housing, wall, coating, or separating wall.

All details and embodiments disclosed above in the section related to the first aspect also apply for the third aspect.

### 4^{th} Aspect—Method for Preparing a Product

The present invention also relates in a fourth aspect to a method for preparing a product comprising
(I) providing a polyethylene terephthalate based polymer of the second aspect;
(II) preparing a textile, a fiber, a packaging, a plastic, an automotive part, an electronic part from the polyalkylene terephthalate based polymer provided in (I).

All details and embodiments disclosed above in the section related to the first aspect also apply for the fourth aspect.

Preferably, what is prepared in (II) is:
a part of a car; preferably cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, A, B, C or D pillar cover, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, or coating;
a cloth; preferably shirt, trousers, pullover, boot, shoe, shoe sole, tight or jacket;
an electrical part; preferably electrical or electronic passive or active component, circuit board, printed circuit board, housing component, foil, line, switch, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), or spring tongue;
a consumer, agricultural product or pharmaceutical product; preferably tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, or pesticide;
a packaging for the food industry; preferably mono- or multi-layer blown film, cast film (mono- or multi-layer), biaxially stretched film, or laminating film; or
a part of a construction; preferably a rotor blade, insulating material, frame, housing, wall, coating, or separating wall.

All details and embodiments disclosed above in the section related to the first aspect also apply for the fourth aspect.

### 5^{th} Aspect—Process for Conversion (Re-Obtained Polyalkylene Terephthalate Based Polymer)

In a fifth aspect, the invention is related to a process, preferably according to the first aspect, comprising the further step:
converting the re-obtained polyalkylene terephthalate based polymer obtained by the process according to the first aspect to obtain a polymer product.

Regarding the polymer product obtained, reference is made to the polymer products listed for the fourth aspect. All details and embodiments disclosed above in the section related to the first aspect also apply for the fifth aspect.

### 6^{h} Aspect—Process for Conversion (Residue)

In a sixth aspect, the invention is related to a process, preferably according to the first aspect, comprising the further step:
converting a residue obtainable by or obtained by the process according to the first aspect, preferably obtained or obtainable from step (b.2) and/or from (x.3), more preferably the residue comprising at least one insoluble polymer selected from PP, PE, PA, natural polymer, viscose and linen obtainable by or obtained by the process according to the first aspect, preferably obtained or obtainable from step (b.2), and/or the soluble polymer obtainable by or obtained by the process according to the first aspect, preferably obtained or obtainable from step (x.3) to obtain one or more monomer, polymer or polymer product.

All details and embodiments disclosed above in the section related to the first aspect also apply for the sixth aspect.

Preferably, the monomer is a di- or polyol; preferably butandiol; aldehyde; preferably formaldehyde; di- or polyisocyanate; preferably methylene diphenyl diisocyanate (MDI), polymeric methylene diphenyl diisocyanate (pMDI), toluene diisocyanate (TDI), hexamethylenediisocyanate (HDI) or isophoronediisocyanate (IPDI); amide; preferably caprolactam; alkene; preferably styrene, ethene and norbornene; alkyne, (di) ester; preferably methyl methacrylate; mono or diacid; preferably adipic acid or terephthalic acid; diamine; preferably hexamethylenediamine, nonanediamine; or sulfones; preferably 4,4′-dichlorodiphenyl sulfone.

Preferably, the polymer is and/or the polymer product comprises polyamide (PA); preferably PA 6 or PA 66; polyisocyanate polyaddition product; preferably polyurethane (PU), thermoplastic polyurethane (TPU), polyurea or polyisocyanurate (PIR); low-density polyethylene (LDPE), high-density polyethylene (HDPE), polyethylene (PE), polypropylene (PP), polyvinyl chloride (PVC), polyvinyl acetate (PVA), polystyrene (PS), poly acrylonitrile butadiene styrene (ABS), poly styrene acrylonitrile (SAN), poly acrylate styrene acrylonitrile (ASA), polytetrafluoroethylene (PTFE), poly(methyl acrylate) (PMA), poly(methyl methacrylate) (PMMA), polybutadiene (BR, PBD), poly(cis-1,4-isoprene), poly(trans-1,4-isoprene), polyoxymethylene (POM), polyethylene terephthalate (PET), polybutylene terephthalate (PBT), polybutylene adipate coterephthalate (PBAT), polyester (PES), polyether sulfone (PESU), polyhydroxyalkanoate (PHA), poly-3-hydroxybutyrate (P3HB), poly-4-hydroxybutyrate (P4HB), polyhydroxyvalerate (PHV), polyhydroxyhexanoate (PHH), polyhydroxyoctanoate (PHO), polylactic acid (PLA), polysulfone (PSU), polyphenylene sulfone (PPSU), polycarbonate (PC), polyether ether ketone (PEEK), poly(p-phenylene oxide) (PPO), poly(p-phenylene ether) (PPE); or copolymer or mixture thereof.

Preferably, the polymer and/or the polymer product is/are or is/are a part of:
a part of a car; preferably cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, A, B, C or D pillar cover, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, or coating;
a cloth; preferably shirt, trousers, pullover, boot, shoe, shoe sole, tight or jacket;
an electrical part; preferably electrical or electronic passive or active component, circuit board, printed circuit board, housing component, foil, line, switch, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), or spring tongue;
a consumer, agricultural product or pharmaceutical product; preferably tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, or pesticide;
a packaging for the food industry; preferably mono- or multi-layer blown film, cast film (mono- or multi-layer), biaxially stretched film, or laminating film; or
a part of a construction; preferably a rotor blade, insulating material, frame, housing, wall, coating, or separating wall.

Preferably, the content of the at least one insoluble polymer selected from PP, PE, PA, natural polymer, viscose and linen and/or of the soluble polymer in the monomer, polymer and/or polymer product is 1 weight-% or more, preferably 2 weight-% or more, more preferably 5 weight-% or more, more preferably 15 weight-% or more, more preferably 30 weight-% or more, more preferably 40 weight-% or more, more preferably 60 weight-% or more, more preferably 80 weight-% or more, more preferably 90 weight-% or more, more preferably 95 weight-% or more; and/or wherein the content of the at least one insoluble polymer selected from PP, PE, PA, natural polymer, viscose and linen and/or of the soluble polymer in the monomer, polymer and/or polymer product is 100 weight-% or less, preferably 95 weight-% or less, more preferably 90 weight-% or less, more preferably 50 weight-% or less, more preferably 25 weight-% or less, more preferably 10 weight-% or less; and preferably wherein the content is determined based on identity preservation and/or segregation and/or mass balance and/or book and claim chain of custody models, preferably based on mass balance, preferably the International Sustainability and Carbon Certification (ISCC) standard.

The converting steps to obtain the monomer, polymer or polymer product may comprise one or more synthesis steps and can be performed by conventional synthesis and technics well known to a person skilled in the art. Independent of the person skilled in the art to assess novelty and inventive step of the independent claim(s), the person skilled in the art to perform the converting step(s) is preferably from the technical field(s) pyrolysis, gasification, remonomerization, depolymerization, synthesis, production of monomers, polymers and polymer compounds, and/or its further processing (e.g. extrusion, injection molding). Examples of the step(s) of the conversion is/are described in “Industrial Organic Chemistry”, 3. volume, Wiley-VCH, 1997, ISBN: 978-3-527-28838-0, “Kunststoffhandbuch”, 11 volumes in 17 sub-volumes, Carl Hanser Verlag; especially volume 6, “Polyamide”, 1. edition, 1966, volume 7, “Polyurethane”, 3. edition, 1993, and volume 8, “Polyester”, 2. edition 1973; “Industrial Organic Chemistry”, 3. volume, Wiley-VCH, 1997, ISBN: 978-3-527-28838-0, “Injection Molding Reference Guide, 4th edition, CreateSpace Independent Publishing Platform, 2011, ISBN: 978-1466407824, EP 0989146 A1, EP 1460094 A1, WO 2006034800 A1, EP 1529792 A1, WO 2006042674 A1, EP 0364854 A2, U.S. Pat. No. 5,506,275 A, EP 0897402 A1, WO 2015082316 A1, WO 2021021855 A1, WO 2021126938 A1, WO 2021021902 A1, WO 2021092311 A1, WO 2008155271 A1, WO 2013139827 A1, each of which is incorporated herein by reference.

The present invention is further illustrated by the following embodiments and combinations of embodiments as indicated by the respective dependencies and back-references. In particular, it is noted that in each instance where a range of embodiments is mentioned, for example in the context of a term such as “The . . . of any of embodiments 1 to 4”, every embodiment in this range is meant to be explicitly disclosed for the skilled person, i.e. the wording of this term is to be understood by the skilled person as being synonymous to “The . . . of any of embodiments 1, 2, 3, and 4”.
1. A process for recovery of polyethylene terephthalate based polymer from a polymeric material, the process comprising:
   (a) providing the polymeric material comprising polyalkylene terephthalate based polymer and providing a solvent system;
   (b) contacting the polymeric material with the solvent system at a temperature T, which is at least 1K, preferably at least 7K, below the boiling temperature of the solvent in the solvent system, which has the lowest boiling point, thereby obtaining a solvent system, which is enriched in dissolved polyalkylene terephthalate based polymer;
   (c) re-obtaining polyalkylene terephthalate based polymer from the solvent system obtained in (b);
   wherein the solvent system comprises one or more solvent(s), wherein
   (s. 1) the solvent system has Hansen solubility parameters with respect to
      energy from dispersion forces between molecules (δDₛₛ),
      energy from dipolar intermolecular force between molecules (δPₛₛ) and
      energy from hydrogen bonds between molecules (δHₛₛ),
      which fulfill equitation 1

(8.8)²≥4(δDₛₛ−20)²+(δPₛₛ−11.8)²+(δHₛₛ−4.5)² [equitation 1];
(s.2) each solvent of the solvent system having a boiling point at 1013 hPa of at least 160 °C; and
(s.3) solvents having a functional group selected from the group consisting of hydroxyl (OH), amino (NH₂), carboxyl (COOH), and thiol (SH) are excluded.
2. The process of embodiment 1, wherein contacting in (b) is done at a temperature in the range of from 160 °C to the temperature T, which is at least 1K, preferably at least 7K, below the boiling temperature of the solvent in the solvent system, which has the lowest boiling point.
3. The process of embodiment 1 or 2, wherein at least 90 weight-%, preferably at least 95 weight-%, more preferably at least 98 weight-%, more preferably at least 99 weight-%, of the solvent system consist of two or more solvent(s), wherein the respective mixture fulfill(s) equitation 1.
4. The process of embodiment 1 tor 2, wherein at least 90 weight-%, preferably at least 95 weight-%, more preferably at least 98 weight-%, more preferably at least 99 weight-%, of the solvent system consist of one solvent, which fulfills equitation 1.
5. The process of any one of embodiments 1 to 4, wherein the one or more solvent(s) is/are selected from the group consisting of N,N-dimethylbenzamide, N, N-dimethylphenylacetamide, 1,4-benzoquinone, acetophenone, dimethyl terephthalate, 1,3,5-trimethoxybenzene, 2-phenylacetophenone, N-methylcaprolactam, methylbenzoate, methyl-4-methoxybenzoate, butylene carbonate, N-ethylpyrrolidone, benzophenone, di-benzyl malonate, N-ethyl-caprolactam, methyl 2-(5-oxotetrahydrofuran-3-yl)acetate (FAME), methyl 2-(5-oxotetrahydrofuran-2-yl)acetate, propiophenone, N-methoxypropyl-pyrrolidone, 1,4-cyclohexanedione, cyclohexane-carbonate, N-methoxyethyl-pyrrolidone, N, N-diethylphenylacetamide, phenyl acetate, 1-(2-hydroxyethyl) pyrrolidin-2-one acetate (HEPAc), N,N-diethylbenzamide, isopropyl-benzoate, cyclohexyl phenyl ketone, phenylacetic acid ethylester, phenylacetat, N-methyl-morpholine, benzyl-propionate, benzylacetate, Neopentyl-glycoldibenzoate, tetrahydrofurfuryl acetate, N-methyl-imidazole, benzyl butyrate, 2-pyrrolidone, 2-phenoxyethanol propionate, 2-phenoxyethyl isobutyrate, N,N-dipropylbenzamide, N,N-dimethylacetamide, N,N-diethylacetamide, dihydrolevoglucosenon (Cyrene), propylenecarbonate, caprolactone, dimethylisosorbide, N-butylpyrrolidone, t-butylpyrrolidone, methyl-1-methyl-5-oxopyrrolidine-3-carboxylate (MMOC), gamma-valerolactone (GVL), delta-valerolactone, gamma butyrolactone, dimethylsulfoxide, methyl 5-(dimethylamino)-2-methyl-5-oxopentanoate (Rhodiasolv Polarclean), caprolactam, phen ethyl acetate, methyl phenylacetate, benzyl benzoate, N,N-dimethyllactamide (Agnique AMD 3L), and dimethyl sulfoxide (DMSO).
6. The process of any one of embodiments 1 to 5, wherein the one or more solvent(s) is/are selected from the group consisting of dihydrolevoglucosenon (Cyrene), propylenecarbonate, caprolactone, dimethylisosorbide, N-butylpyrrolidone, t-butylpyrrolidone, methyl-1-methyl-5-oxopyrrolidine-3-carboxylate (MMOC), gamma-valerolactone (GVL), Delta-valerolactone, gamma butyrolactone, dimethylsulfoxide, methyl 5-(dimethylamino)-2-methyl-5-oxopentanoate (Rhodiasolv® Polarclean), caprolactam, phen ethyl acetate, methyl phenylacetate, benzyl benzoate, phenyl benzoate, methyl benzoate, propyl benzoate, and dimethyl sulfoxide (DMSO).
7. The process of any one of embodiments 1 to 6, wherein the one or more solvent(s) is/are selected from the group consisting of propylenecarbonate, N-butylpyrrolidone, t-butylpyrrolidone, methyl-1-methyl-5-oxopyrrolidine-3-carboxylate (MMOC), Delta-valerolactone, gamma butyrolactone, methyl 5-(dimethylamino)-2-methyl-5-oxopentanoate (Rhodiasolv® Polarclean), caprolactam, phen ethyl acetate, methyl phenylacetate, benzyl benzoate, phenyl benzoate, methyl benzoate, and propyl benzoate.
8. The process of any one of embodiments 1 to 7, wherein the one or more solvent(s) is/are selected from the group consisting of propylenecarbonate, N-butylpyrrolidone, t-butylpyrrolidone, methyl-1-methyl-5-oxopyrrolidine-3-carboxylate (MMOC), methyl 5-(dimethylamino)-2-methyl-5-oxopentanoate (Rhodiasolv® Polarclean), and phenethyl acetate.
9. The process of any one of embodiments 1 to 8, wherein the one or more solvent(s) is/are selected from the group consisting of gamma valerolactone (GVL), N-butylpyrrolidone (NBP), propylenecarbonate, acetophenone dimethyl sulfoxide (DMSO), dihydrolevoglucosenon (Cyrene) and mixtures of two or more thereof, or from the group consisting of N-butylpyrrolidone (NBP), propylenecarbonate, acetophenone dimethyl sulfoxide (DMSO), dihydrolevoglucosenon (Cyrene) and mixtures of two or more thereof.
10. The process of any one of embodiments 1 to 9, wherein the one or more solvent(s) is/are selected from the group consisting of GVL, NBP, propylenecarbonate, acetophenone, DMSO and mixtures of two or more thereof, or from the group consisting of NBP, propylenecarbonate, acetophenone, DMSO and mixtures of two or more thereof.
11. The process of any one of embodiments 1 to 10, wherein the one or more solvent(s) is/are selected from the group consisting of GVL, NBP, propylenecarbonate, acetophenone and mixtures of two or more thereof, or from the group consisting of NBP, propylenecarbonate, acetophenone and mixtures of two or three thereof.
12. The process of any one of embodiments 1 to 11, wherein the one or more solvent(s) comprise at least gamma valerolactone (GVL), preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) are GVL, based on a total weight of the one or more solvent(s) being 100 weight-%, more preferably the one solvent is GVL, or
   wherein the one or more solvent(s) comprise at least N-butylpyrrolidone (NBP), preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) are NBP, based on a total weight of the one or more solvent(s) being 100 weight-%, more preferably the one solvent is NBP; or
   wherein the one or more solvent(s) comprise at least propylenecarbonate, preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) are propylenecarbonate, based on a total weight of the one or more solvent(s) being 100 weight-%, more preferably the one solvent is propylenecarbonate; or
   wherein the one or more solvent(s) comprise at least acetophenone, preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) are acetophenone, based on a total weight of the one or more solvent(s) being 100 weight-%, more preferably the one solvent is acetophenone; or
   wherein the one or more solvent(s) comprise at least dimethyl sulfoxide (DMSO), preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) are DMSO, based on a total weight of the one or more solvent(s) being 100 weight-%, more preferably the one solvent is DMSO; or
   wherein the one or more solvent(s) comprise at least dihydrolevoglucosenon (Cyrene), preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) are Cyrene, based on a total weight of the one or more solvent(s) being 100 weight-%, more preferably the one solvent is Cyrene.
13. The process of any one of embodiments 1 to 12, wherein ethyl benzoate and butyl benzoate are excluded as solvent(s).
14. The process of any one of embodiments 1 to 13, wherein the re-obtained polyalkylene terephthalate based polymer of (c) has a number average molecular weight Mn, which is greater or at least equal to the Mn of the polyalkylene terephthalate based polymer comprised in the polymeric material provided in (a).
15. The process of any one of embodiments 1 to 14, wherein the re-obtained polyalkylene terephthalate based polymer of (c) has a dispersity Mw/Mn (Mass average molecular weight Mw divided by number average molecular weight Mn) in the range of from 70 to 95%, preferably in the range of from 75 to 90% of the dispersity Mw/Mn of the polyalkylene terephthalate based polymer comprised in the polymeric material provided in (a) (100%).
16. The process of any one of embodiments 1 to 15, wherein at least 50 weight-%, preferably at least 60 weight-%, more preferably at least 70 weight-%, more preferably at least 80 weight-%, more preferably at least 90 weight-%, more preferably at least 95 weight-%, more preferably at least 98 weight-% of the polymeric material comprising polyalkylene terephthalate based polymer are polyalkylene terephthalate based polymer, based on the total weight of the polymeric material comprising polyalkylene terephthalate based polymer being 100 weight-%.
17. The process of any one of embodiments 1 to 15, wherein the polymeric material comprisesing polyalkylene terephthalate based polymer further comprises at least one polymer different from polyalkylene terephthalate based polymer and optionally at least one colorant.
18. The process of embodiment 17, wherein at least 40 weight-%, more preferably at least 50 weight-%, more preferably at least 60 weight-%, more preferably at least 70 weight-%, more preferably at least 80 weight-%, more preferably at least 90 weight-% of the polymeric material comprising polyalkylene terephthalate based polymer are polyalkylene terephthalate based polymer, and at the outmost 60 weight-%, more preferably at the outmost 50 weight-%, more preferably at the outmost 40 weight-%, more preferably at the outmost 30 weight-%, more preferably at the outmost 20 weight-%, more preferably at the outmost 10 weight-% of the polymeric material comprising polyalkylene terephthalate based polymer are at least one polymer different from polyalkylene terephthalate based polymer and optionally at least one colorant, each based on the total weight of the polymeric material comprising polyalkylene terephthalate based polymer being 100 weight-%.
19. The process of any one of embodiments 1 to 18, wherein the polyalkylene terephthalate based polymer consists of either oxyethylen units or oxybutylen units and oxyterephthaloyl units, wherein in case of oxyethylen units, in the range of from 0 to 5 mol-% of the oxyterephthaloyl units are replaced by oxyisophthaloyl units and/or in the range of from 0 to 49 mol-% of the oxyethylen units are replaced by oxymethylene cyclohexylene methylene units; wherein more preferably, the polyalkylene terephthalate based polymer is selected from the group consisting of PET (polyethylene terephthalate), PETI (poly(ethylene terephthalate-co-isophthalate)), PBT (polybutylene terephthalate), and mixtures of two or three of these polymers; wherein more preferably the polyalkylene terephthalate based polymer comprises or is PET.
20. The process of any one of embodiments 1 to 19, wherein polymeric material comprising polyalkylene terephthalate based polymer and solvent system are contacted in a mass-based ratio solventsystem:polymeric material in the range of from 1:1 to 100:1, preferably in the range of from 1:1 to 50:1, more preferably in the range of from 1:1 to 20:1, more preferably in the range of from 1:1 to 10:1.
21. The process of any one of embodiments 1 to 20, wherein (b) and (c), preferably (a), (b) and (c) are done at a pressure in the range of from 800 to 200,000 hPa.
22. The process of any one of embodiments 1 to 21, wherein (b), if at least one insoluble polymer different from polyalkylene terephthalate based polymer is present in the provided polymeric material, comprises
   (b.1) contacting the polymeric material with the solvent system at a temperature T, which is at least 1K, preferably at least 7K, below the boiling temperature of the solvent in the solvent system, which has the lowest boiling point, thereby obtaining a solvent system, which is enriched in dissolved polyalkylene terephthalate based polymer and a residue, preferably comprising at least one insoluble polymer selected from PP, PE, PA, natural polymer, viscose and linen;
   (b.2) optionally separation of the solvent system, which is enriched in dissolved polyalkylene terephthalate based polymer from the residue, thereby obtaining an insoluble polymer-free solvent system enriched in dissolved polyalkylene terephthalate based polymer and a residue, preferably comprising at least one insoluble polymer selected from PP, PE, PA, natural polymer, viscose and linen.
23. The process of any one of embodiments 1 to 22, wherein (c) comprises:
   (c.1) optionally after heated filtration, cooling the solvent system obtained in (b), which is enriched in dissolved polyalkylene terephthalate based polymer compared to the solvent system provided in (a) or the insoluble polymer-free solvent system enriched in dissolved polyalkylene terephthalate based polymer obtained in (b.2), to a temperature below 160 °C, preferably below 150 °C, more preferably below 140 °C, more preferably below 120 °C;
   (c.2) obtaining a precipitated polyalkylene terephthalate based polymer and a solvent system, which is depleted in dissolved polyalkylene terephthalate based polymer.
24. The process of embodiment 23, wherein cooling in (c.1) is done without addition of anti-solvents.
25. The process of any one of embodiments 1 to 24 comprising
   (d) separating the precipitated polyalkylene terephthalate based polymer obtained in (c) or (c.2) from the solvent system, which is depleted in dissolved polyalkylene terephthalate based polymer, thereby obtaining a precipitated polyalkylene terephthalate based polymer and the solvent system, which is depleted in dissolved polyalkylene terephthalate based polymer.
26. The process of any one of embodiments 1 to 25 comprising
   (e) optionally washing the precipitated polyalkylene terephthalate based polymer obtained in (d);
   (f) drying the precipitated polyalkylene terephthalate based polymer obtained in (d) or the washed precipitated polyalkylene terephthalate based polymer obtained in (e).
27. The process of any one of embodiments 1 to 26 wherein the process, if at least one soluble polymer different from polyalkylene terephthalate is present in the polymeric material, comprises:
   (x) contacting the polymeric material with a solvent system at a temperature T₁ of <170 °C, thereby obtaining a solvent system, which is enriched in dissolved further polymer, and a residue of the polymeric material, which is depleted of said further polymer, and comprises the polyalkylene terephthalate;
   wherein step (x) is preferably carried out prior to step (b).
28. The process of embodiment 27, wherein the at least one soluble polymer comprises, preferably is, an elastic fiber.
29. The process of embodiment 27 or 28, wherein (x) comprises
   (x.1) contacting the polymeric material with a solvent system at a temperature T₁ of <170 °C, thereby obtaining a solvent system, which is enriched in dissolved soluble polymer, and a residue of the polymeric material, wherein said residue is depleted of said soluble polymer, and said residue comprises the polyalkylene terephthalate;
   (x.2) separating the solvent system, which is enriched in dissolved soluble polymer obtained in (x.1) from the residue, preferably by a physical separation method, thereby obtaining a separated solvent system, which is enriched in dissolved soluble polymer, compared to the solvent system used for contacting in (x.1) and a residue of the polymeric material, wherein said residue is depleted of said soluble polymer, and said residue comprises the polyalkylene terephthalate; and
   (x.3) optionally separating the soluble polymer from the solvent system, thereby obtaining a separated fraction comprising the soluble polymer.
30. The process of any one of embodiments 27 to 29, wherein (x) comprises
   (x.4) washing the residue of the polymeric material obtained in (x.2) with a washing solvent, thereby obtaining a washed residue, which is depleted of said further polymer, and comprises the polyalkylene terephthalate;
   (x.5) optionally drying the washed residue comprises the polyalkylene terephthalate obtained in (x.4), thereby obtaining a dried and washed residue comprising the polyalkylene terephthalate.
31. The process of any one of embodiments 27 to 30, wherein contacting in (x) or (x. 1) is done in a mass-based ratio solventsystem:polymeric material in the range of from 1:1 to 100:1, preferably in the range of from 1:1 to 50:1, more preferably in the range of from 1:1 to 20:1, more preferably in the range of from 1:1 to 10:1.
32. The process of any one of embodiments 27 to 31, wherein (x) or one or more of (x.1) to (x.5), preferably (x.1) to (x.5) are done at a pressure in the range of from 800 to 200,000 hPa.
33. The process of any one of embodiments 27 to 32, wherein the solvent system used for contacting in (x) or (x. 1) is as defined in any one of embodiments 1 to 13, wherein preferably, the same solvent as provided in (a) and used for contacting in (b) is used for contacting in (x) or (x.1).
34. The process of any one of embodiments 1 to 33, wherein the polymeric material contacted with solvent system in step (b) is the separated residue of the polymeric material, which is depleted of soluble polymer, and comprises the polyalkylene terephthalate obtained in (x.2) the washed residue comprises the polyalkylene terephthalate obtained in (x.4) and/or the dried washed residue obtained in (x.5).
35. Polyalkylene terephthalate based polymer obtained or obtainable from the process of any one of embodiments 1 to 34, preferably obtained or obtainable from step (d), (e), (f) or (x), more preferably from step (f).
36. Use of the polyalkylene terephthalate based polymer of embodiment 35 for textile applications, fiber applications, packaging applications, plastic applications, automotive applications, electronic applications, preferably for the production of food packaging, beverage packaging, clothing, foot wear, wire, cable, wherein preferably for textile applications, fiber applications, packaging applications, plastic applications, more preferably for the production of food packaging, beverage packaging, clothing and foot wear.
37. The use of embodiment 36 for:
   a part of a car; preferably cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, A, B, C or D pillar cover, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, or coating;
   a cloth; preferably shirt, trousers, pullover, boot, shoe, shoe sole, tight or jacket;
   an electrical part; preferably electrical or electronic passive or active component, circuit board, printed circuit board, housing component, foil, line, switch, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), or spring tongue;
   a consumer, agricultural product or pharmaceutical product; preferably tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, or pesticide;
   a packaging for the food industry; preferably mono- or multi-layer blown film, cast film (mono- or multi-layer), biaxially stretched film, or laminating film; or
   a part of a construction; preferably a rotor blade, insulating material, frame, housing, wall, coating, or separating wall.
38. A method for preparing a product comprising
   (I) providing polyalkylene terephthalate based polymer of embodiment 35;
   (II) preparing a textile, a fiber, a packaging, a plastic, an automotive part, an electronic part from the polyalkylene terephthalate based polymer provided in (I).
39. The method of embodiment 38, wherein in (II)
   a part of a car; preferably cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, cover for car A, B, C or D pillar, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, or coating;
   a cloth; preferably shirt, trousers, pullover, boot, shoe, shoe sole, tight or jacket;
   an electrical part; preferably electrical or electronic passive or active component, circuit board, printed circuit board, housing component, foil, line, switch, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), or spring tongue;
   a consumer, agricultural product or pharmaceutical product; preferably tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, or pesticide;
   a packaging for the food industry; preferably mono- or multi-layer blown film, cast film (mono- or multi-layer), biaxially stretched film, or laminating film; or a part of a construction; preferably a rotor blade, insulating material, frame, housing, wall, coating, or separating wall, is prepared.
40. Process, preferably according to any one of embodiments 1 to 34, comprising the further step:
   converting the re-obtained polyalkylene terephthalate based polymer obtained by the process according to any one of embodiments 1 to 34 to obtain a polymer product.
41. Process, preferably according to any one of embodiments 1 to 34, comprising the further step:
   converting a residue obtainable by or obtained by the process according to any one of embodiments 1 to 34, preferably obtained or obtainable from step (b.2), more preferably the residue comprising at least one insoluble polymer selected from PP, PE, PA, natural polymer, viscose and linen obtainable by or obtained by the process according to the first aspect, preferably obtained or obtainable from step (b.2) and/or the soluble polymer obtainable by or obtained by the process according to the first aspect, preferably obtained or obtainable from step (x.3),
   to obtain one or more monomer, polymer or polymer product.
42. Process according to embodiment 41,
   wherein the monomer is a di- or polyol; preferably butandiol; aldehyde; preferably formaldehyde; di- or polyisocyanate; preferably methylene diphenyl diisocyanate (MDI), polymeric methylene diphenyl diisocyanate (pMDI), toluene diisocyanate (TDI), hexamethylenediisocyanate (HDI) or isophoronediisocyanate (IPDI); amide; preferably caprolactam; alkene; preferably styrene, ethene and norbornene; alkyne, (di) ester; preferably methyl methacrylate; mono or diacid; preferably adipic acid or terephthalic acid; diamine; preferably hexamethylenediamine, nonanediamine; or sulfones; preferably 4,4′-dichlorodiphenyl sulfone.
43. Process according to embodiment 41 or 42,
   wherein the polymer is and/or the polymer product comprises polyamide (PA); preferably PA 6 or PA 66; polyisocyanate polyaddition product; preferably polyurethane (PU), themoplastic polyurethane (TPU), polyurea or polyisocyanurate (PIR); low-density polyethylene (LDPE), high-density polyethylene (HDPE), polyethylene (PE), polypropylene (PP), polyvinyl chloride (PVC), polyvinyl acetate (PVA), polystyrene (PS), poly acrylonitrile butadiene styrene (ABS), poly styrene acrylonitrile (SAN), poly acrylate styrene acrylonitrile (ASA), polytetrafluoroethylene (PTFE), poly(methyl acrylate) (PMA), poly(methyl methacrylate) (PMMA), polybutadiene (BR, PBD), poly(cis-1,4-isoprene), poly(trans-1,4-isoprene), polyoxymethylene (POM), polyethylene terephthalate (PET), polybutylene terephthalate (PBT), polybutylene adipate coterephthalate (PBAT), polyester (PES), polyether sulfone (PESU), polyhydroxyalkanoate (PHA), poly-3-hydroxybutyrate (P3HB), poly-4-hydroxybutyrate (P4HB), polyhydroxyvalerate (PHV), polyhydroxyhexanoate (PHH), polyhydroxyoctanoate (PHO), polylactic acid (PLA), polysulfone (PSU), polyphenylene sulfone (PPSU), polycarbonate (PC), polyether ether ketone (PEEK), poly(p-phenylene oxide) (PPO), poly(p-phenylene ether) (PPE); or copolymer or mixture thereof.
45. Process according to any one of embodiments 41 to 44, wherein the polymer and/or the polymer product is/are or is/are a part of:
   a part of a car; preferably cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, cover for car A, B, C or D pillar, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, or coating;
   a cloth; preferably shirt, trousers, pullover, boot, shoe, shoe sole, tight or jacket;
   an electrical part; preferably electrical or electronic passive or active component, circuit board, printed circuit board, housing component, foil, line, switch, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), or spring tongue;
   a consumer, agricultural product or pharmaceutical product; preferably tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, or pesticide;
   a packaging for the food industry; preferably mono- or multi-layer blown film, cast film (mono- or multi-layer), biaxially stretched film, or laminating film; or
   a part of a construction; preferably a rotor blade, insulating material, frame, housing, wall, coating, or separating wall.
46. Process according to any one of embodiments 41 to 45,
   wherein the content of the at least one insoluble polymer selected from PP, PE, PA, natural polymer, viscose and linen and/or of the insoluble polymer in the monomer, polymer and/or polymer product is 1 weight-% or more, preferably 2 weight-% or more, more preferably 5 weight-% or more, more preferably 15 weight-% or more, more preferably 30 weight-% or more, more preferably 40 weight-% or more, more preferably 60 weight-% or more, more preferably 80 weight-% or more, more preferably 90 weight-% or more, more preferably 95 weight-% or more; and/or
   wherein the content of the at least one insoluble polymer selected from PP, PE, PA, natural polymer, viscose and linen and/or of the insoluble polymer in the monomer, polymer and/or polymer product is 100 weight-% or less, preferably 95 weight-% or less, more preferably 90 weight-% or less, more preferably 50 weight-% or less, more preferably 25 weight-% or less, more preferably 10 weight-% or less; and
   preferably wherein the content is determined based on identity preservation and/or segregation and/or mass balance and/or book and claim chain of custody models, preferably based on mass balance, preferably the International Sustainability and Carbon Certification (ISCC) standard.

The present invention is further illustrated by the following reference examples, comparative examples, and examples.

### EXAMPLES

### Methods

### GPC (Gel-Permeation Chromatography):

### Sample Preparation:

7.5 mg sample was dissolved in 5 ml eluent (hexafluorisopropanol+0.05 weight-% trifluoro potassium acetate) over night. All sample solutions were filtered by a Millipore Millex FG (0.2 μm) filtered prior to injection. Sealed sample vials were placed into the auto sampler.

### Experimental Conditions:

An Agilent 1100 HPLC system, consisting of an isocratic pump, vacuum degasser, auto sampler and a column oven (40 °C) was used. Furthermore, the Agilent system contained as detectors a Differential Refractive Index (DRI) and a variable Ultra Violet (UVW) Detector. Data acquisition and data processing of conventionally SEC data were done by WinGPC Unichrom, of PSS (Polymer Standard Services). A combination of a PL-HFIP guard (7.5×50 mm) column and 2 PL-HFIP Gel columns (7.5×300 mm, 9μ) of Agilent were put in series. As an eluent, hexafluorisopropanol+0.05 weight-% trifluoro potassium acetate was used as a flow rate of 1 ml/min. Of each sample solution 50 μl was injected. The calibration was obtained by narrow molar mass distributed PMMA standards (Polymer Standard Services) having a molar mass range of M=800 till M=2.200.000 g/mol. Molar masses outside this range were extrapolated.

### Chemicals

| | |
|---|---|
| (Chemical) name | Abbreviation |

polymeric material

| | |
|---|---|
| polyethylene terephthalate | PET |
| block copolymer comprising polyurethane and | Elastic fiber |
| polyethylene glycol or pTHF (≥85 weight-% | (Elastane, Spandex) |
| polyurethane) | |

solvents

| | |
|---|---|
| water | — |
| acetone | — |
| dihydrolevoglucosenon | cyrene |
| propylenecarbonate | — |
| epsilon-caprolactone | caprolactone |
| 2,5-dimethylisosorbide | — |
| N-butylpyrrolidone | — |
| t-butylpyrrolidone | — |
| methyl-1-methyl-5-oxopyrrolidine-3- | MMOC |
| carboxylate | |
| gamma-valerolactone | GVL |
| delta-valerolactone | DVL |
| gamma butyrolactone | GBL |
| dimethylsulfoxide | DMSO |
| methyl 5-(dimethylamino)-2-methyl-5- | Rhodiasolv ®Polarclean |
| oxopentanoate | |
| caprolactam | — |
| phenetyl acetate | — |
| acetophenone | — |
| methyl phenylacetate | — |
| menzyl benzoate | — |
| N,N-dimethyllactamide | Agnique ®AMD 3L |
| glycerol triacetate | — |
| fimethyl succinate | — |
| 2-ethylhexyl acetate | — |
| cyclohexanone | — |
| 1-octanol | — |
| 1-(2-hydroxyethyl)pyrrolidin-2-one | HEP |
| 1-methyl-4-(propan-2-yl)benzene | p-cymene |
| ethyl levulinate | — |
| dimethylformamide | DMF |

### Reference Example 1: General Procedure-Dissolution of PET

Polymeric material (in any color) was cut/shredded into pieces and placed in a reaction vessel (e.g. flask, tube, reaction vessel). The solvent was added (in mass-based ratio solvent:polymeric material 100:1 to 1:1, preferred 10:1-1:1) and the mixture was heated by use of a suitable heating system (e.g. oil bath, heating blocks, mini-plant vessels) to maximum of a) the respective boiling point of the solvent, or b) to 210 °C, both under an inert gas atmosphere, wherein PET was fully dissolved upon visual inspection. After 1 to 30 min the mixture was allowed to cool-down while the PET precipitated. The precipitate was filtrated and washed with a small amount of the individual solvent. For an easy removal of said solvent and a faster drying process of the re-obtained colorless PET powder, small amounts of acetone could be used in a second washing step. The thus obtained solid was dried (for example in a vacuum compartment dryer).

The samples were analysed before treatment (polymeric material having any color), and after the final drying step (recycled and re-obtained colorless PET solid) in that number average molecular weight Mn, mass average molecular weight Mw, dispersity Mw/Mn were determined. These data are summarized for the starting material in Table 1.

TABLE 1
GPC analytics of the starting material.

| Number | Mass | |
|---|---|---|
| average Mn | average Mw | Dispersity |
| [g/mol] | [g/mol] | Mw/Mn |
| 18,000 | 53,200 | 3.0 |

### Examples 1 to 16 and Comparative Examples 1 to 10: Dissolution or Non-Dissolution of PET

PET having Hansen parameters according to the 5^{th} Edition 5.1.03 (2008) of the HANSEN Solubility Parameters in Practice (HSPIP) of δD=18.2, δP=6.4 and δH=6.6 was treated according to the procedure of Reference Example 1. The conditions and results are summarized in Table 2.

TABLE 2
Dissolution or Non-dissolution of PET

| | | | | | | | Number | Mass | | |
|---|---|---|---|---|---|---|---|---|---|---|
| | | | | | | | average | average | | |
| | | Boiling | | | | | molecular | molecular | | |
| | | temperature | HANSEN | | | Dissolution | weight | weight | | |
| | | [°C] | parameter* | | | temperature | Mn | Mw | Dispersity | Experimental |
| | Solvents | (at 1013 hPa) | δD | δP | δH | [°C] | [g/mol] | [g/mol] | Mw/Mn | solubility** |
| Example (E) # | | | | | | | | | | |
| 1 | cyrene | 227 | 18.35 | 11.25 | 7.00 | 165 | 20,700 | 47,800 | 2.3 | Yes |
| 2 | propylenecarbonate | 242 | 19.25 | 17.02 | 5.22 | 195 | 19,800 | 43,600 | 2.2 | Yes |
| 3 | caprolactone | 235 | 17.77 | 11.43 | 7.08 | 170 | 21,400 | 47,500 | 2.2 | Yes |
| 4 | 2,5-Dimethylisosorbide | 235 | 17.59 | 11.50 | 6.89 | 195 | 21,300 | 47,100 | 2.2 | Yes |
| 5 | N-butylpyrrolidone | 241 | 17.49 | 9.25 | 6.20 | 190 | 20,800 | 46,800 | 2.3 | Yes |
| 6 | t-butylpyrrolidone | 227 | 17.81 | 12.53 | 6.60 | 200 | 20,400 | 46,200 | 2.3 | Yes |
| 7 | MMOC | 264 | 17.93 | 16.13 | 8.34 | 190 | 21,500 | 48,100 | 2.2 | Yes |
| 8 | GVL | 205 | 18.50 | 14.17 | 7.93 | 185 | 22,500 | 50,900 | 2.3 | Yes |
| 9 | DVL | 230 | 18.43 | 14.21 | 8.68 | 180 | 21,700 | 47,800 | 2.2 | Yes |
| 10 | GBL | 204-206 | 18.00 | 15.97 | 7.63 | 175 | 22,300 | 50,600 | 2.3 | Yes |
| 11 | DMSO | 189 | 17.80 | 16.56 | 10.37 | 190 | 18,500 | 41,100 | 2.2 | Yes |
| 12 | Rhodiasolv ®PolarClean | 278-282 | 16.28 | 8.90 | 7.84 | 205 | 20,500 | 45,400 | 2.2 | Yes |
| 13 | caprolactam | 270 | 18.90 | 13.09 | 7.79 | 190 | 18,000 | 40,100 | 2.2 | Yes |
| 14 | methyl-phenyl acetate | 218 | 18.56 | 7.42 | 6.21 | 190 | 20,500 | 52,000 | 2.5 | Yes |
| 15 | phenylethyl acetate | 238-239 | 18.16 | 7.50 | 5.83 | 205 | 19,700 | 48,600 | 2.5 | Yes |
| 16 | acetophenone | 202 | 19.0 | 8.20 | 4.70 | 175 | 20000 | 48900 | 2.4 | Yes |
| Comparative | | | | | | | | | | |
| Example (CE) # | | | | | | | | | | |
| 1 | Agnique ®AMD 3L | 224 | 16.55 | 11.49 | 15.18 | 195 | 7,660 | 15,500 | 2.0 | “Yes”*** |
| 2 | DMF | 153 | 16.88 | 14.10 | 10.33 | | | | | No |
| 3 | glycerol triacetate | 257-259 | 116.41 | 6.24 | 8.53 | | | | | No |
| 4 | dimethyl succinate | 196 | 16.16 | 7.42 | 8.73 | | | | | No |
| 5 | 2-ethylhexylacetate | 199 | 15.77 | 3.25 | 5.18 | | | | | No |
| 6 | cyclohexanone | 156 | 17.82 | 8.33 | 5.27 | | | | | No |
| 7 | 1-octanol | 195 | 15.96 | 5.11 | 11.22 | | | | | No |
| 8 | HEP | 306-309 | 18.04 | 9.05 | 14.50 | | | | | No |
| 9 | p-cymene | 177 | 18.16 | 0.33 | 1.01 | | | | | No |
| 10 | ethyl levulinate | 203-205 | 16.24 | 7.29 | 8.62 | | | | | No |

*Hansen parameter from BIOVIA COSMOquick 2022
**soluble upon visual inspection
***Agnique ®AMD 3L was able to dissolve PET, however with a huge decline in number average molecular weight Mn (and also in Mw) of the re-obtained PET and would thus not be suitable for polymer-to-polymer recycling

It was found that surprisingly all solvents having Hansen parameters fulfilling equitation 1 (s, 1) and having features (s.2) and (s.3) were able to dissolve PET without harming at least the number average molecular weight Mn of the re-obtained PET—the Mn of the re-obtained PET was always greater or at least equal to the Mn of the PET comprised in the material initially provided. The re-obtained PET had a dispersity Mw/Mn (Mass average molecular weight Mw divided by number average molecular weight Mn) in the range of from 70 to 95%, preferably in the range of from 75 to 90% of the dispersity Mw/Mn of the polyalkylene terephthalate based polymer comprised in the polymeric material provided in (a) (100%). When a solvent system was used not fulfilling equitation 1, for example, Agnique@AMD 3L, it was found that this was able to dissolve PET, but resulted in a huge decline in both Mn and Mw.

### Reference Example 2: General Procedure-Dissolution of Elastic Fiber Prior to Dissolution of PET

5 g of elastic fiber (respective to a textile sample comprising 50 weight-% of elastic fiber when a ratio of 1:10 (textile to solvent) was applied) and 100 mL of the respective solvent were placed in a reaction vessel (e.g. flask, tube, reaction vessel). The mixture was heated to 150 °C under a gentle nitrogen flow and upon visual inspection it was observed if and when elastic fiber was fully dissolved.

### Examples 17, 18: Dissolution of Elastic Fiber

5 g of elastic fiber were treated with N-butylpyrrolidone (Example 17) or with acetophenone (Example 18) according to Reference Example 2. A complete dissolution of the elastic fiber was observed.

### CITED LITERATURE

WO 2016/12755 A1
Wenjun Chen, Yuechao Yang, Xue Lan, Baolong Zhang, Xiaogang Zhang and Tiancheng Mu in Green Chem., 2021, 23, 4065
WO 2022/221832 A1
“Dyes and Pigments” Metin Açikyildiz, Kübra Günes, Ahmet Gürses Springer, 2016 (ISBN: 10:3319338900)
Industrial Organic Pigments—Klaus Hunger, Thomas Heber, Martin U. Schmidt, Friedrich Reisinger, Stefan Wanne Wiley-VCH, 4^{th} edition, 2018 (ISBN: 978-3-527-32608-2)
Chemistry and Technology of Natural and Synthetic Dyes and Pigments—Ashis Kumar Samanta, Nasser Awwad, IntechOpen, 2020 (ISBN: 9781789859980, 9781789859973, 9781839687587)
Encyclopedia of Color, Dyes, Pigments—Volume 1, Gerhard Pfaff, de Gruyter, 2021 (ISBN: 311058588X)
Heinrich Zollinger: Color Chemistry: Syntheses, Properties, and Applications of Organic Dyes and Pigments. 3^{rd} edition. WILEY-VCH Verlag, Weinheim 2003 (ISBN: 3-906390-23-3)
Klaus Hunger (Ed.): Industrial Dyes: Chemistry, Properties, Applications. WILEY-VCH Verlag, Weinheim 2003 (ISBN: 3-662-01950-7)
Hermann Rath: Lehrbuch der Textilchemie. einschl. der textilchemischen Technologie. 2nd edition. Springer-Verlag, Berlin, Heidelberg 1963 (ISBN: 978-3-662-00065-6)
Wilfried Kratzert, Rasmus Peichert: Farbstoffe. Quelle & Meyer, Heidelberg 1981 (ISBN: 3-494-01021-8)
Ullmann's Encyclopedia of industrial chemistry, Wiley-VCH, 2000, sections “dyes and pigments” and “dyes, general survey” (ISBN: 9783527303854)
“Industrial Organic Chemistry”, 3. volume, Wiley-VCH, 1997, ISBN: 978-3-527-28838-0,
“Kunststoffhandbuch”, Carl Hanser Verlag; vol. 6, “Polyamide”, 1. edition, 1966,
“Kunststoffhandbuch”, Carl Hanser Verlag; vol. 7, “Polyurethane”, 3. edition, 1993,
Kunststoffhandbuch”, Carl Hanser Verlag; vol. 8, “Polyester”, 2. edition 1973;
“Industrial Organic Chemistry”, 3. volume, Wiley-VCH, 1997, ISBN: 978-3-527-28838-0,
“Injection Molding Reference Guide, 4th edition, CreateSpace Independent Publishing Platform, 2011, ISBN: 978-1466407824,
EP0989146 A1
EP 1460094 A1
W O2006034800 A1
EP 1529792 A1
WO 2006042674 A1
EP 0364854 A2
U.S. Pat. No. 5,506,275 A
EP 0897402 A1
WO 2015082316 A1
WO 2021021855 A1
WO 2021126938 A1
WO 2021021902 A1
WO 2021092311 A1
WO 2008155271 A1
WO 2013139827 A1

1. A process for recovery of a polyethylene terephthalate based polymer from a polymeric material, the process comprising:
(a) providing the polymeric material comprising polyalkylene terephthalate based polymer and providing a solvent system comprising N-butylpyrrolidone;
(b) contacting the polymeric material with the solvent system at a temperature T, which is at least 1K below the boiling temperature of the solvent in the solvent system, which has the lowest boiling point, thereby obtaining a solvent system, which is enriched in dissolved polyalkylene terephthalate based polymer; and
(c) re-obtaining polyalkylene terephthalate based polymer from the solvent system obtained in (b).

2. The process according to claim 1, wherein contacting in (b) is done at a temperature in the range of from 160 °C to the temperature T, which is at least 1K below the boiling temperature of the solvent in the solvent system, which has the lowest boiling point.

3. The process according to claim 1, wherein the re-obtained polyalkylene terephthalate based polymer of (c) has a number average molecular weight Mn, which is greater or at least equal to the Mn of the polyalkylene terephthalate based polymer comprised in the polymeric material provided in (a).

4. The process of according to claim 1, wherein the re-obtained polyalkylene terephthalate based polymer of (c) has a dispersity Mw/Mn (Mass average molecular weight Mw divided by number average molecular weight Mn) in the range of from 70 to 95% of the dispersity Mw/Mn of the polyalkylene terephthalate based polymer comprised in the polymeric material provided in (a) (100%).

5. The process of according to claim 1, wherein polymeric material comprising polyalkylene terephthalate based polymer and solvent system are contacted in a mass-based ratio solventsystem:polymeric material in the range of from 1:1 to 100:1.

6. The process of according to claim 1, wherein (b), if at least one insoluble polymer is present, comprises;
(b.1) contacting the polymeric material with the solvent system at a temperature T, which is at least 1K below the boiling temperature of the solvent in the solvent system, which has the lowest boiling point, thereby obtaining a solvent system, which is enriched in dissolved polyalkylene terephthalate based polymer and a residue; and
(b.2) optionally separating the solvent system, which is enriched in dissolved polyalkylene terephthalate based polymer from the residue, thereby obtaining an insoluble polymer-free solvent system enriched in dissolved PET and a residue.

7. The process according to claim 1,
wherein (c) comprises:
(c.1) optionally after heated filtration, cooling the solvent obtained in (b), which is enriched in dissolved polyalkylene terephthalate based polymer or the insoluble polymer-free solvent system enriched in dissolved polyalkylene terephthalate based polymer obtained in (b.2) to a temperature below 160 °C; and
(c.2) obtaining a precipitated polyalkylene terephthalate based polymer and a solvent, which is depleted in dissolved polyalkylene terephthalate based polymer.

8. The process according to claim 1, comprising:
(d) separating the precipitated polyalkylene terephthalate based polymer obtained in (c) or (c.2) from the solvent, which is depleted in dissolved polyalkylene terephthalate based polymer, thereby obtaining a precipitated polyalkylene terephthalate based polymer and the solvent, which is depleted in dissolved polyalkylene terephthalate based polymer; and
(e) optionally washing the precipitated polyalkylene terephthalate based polymer obtained in (d).

9. The process according to claim 1, comprising, if at least one soluble polymer different from polyalkylene terephthalate is present in the polymeric material:
(x) contacting the polymeric material with a solvent system at a temperature T₁ of <170 °C, thereby obtaining a solvent system, which is enriched in dissolved soluble polymer, and a residue of the polymeric material, wherein said residue is depleted of said soluble polymer, and said residue comprises the polyalkylene terephthalate.

10. The process according to claim 1, wherein the polyalkylene terephthalate based polymer comprises or is PET.

11. A polyalkylene terephthalate based polymer obtained from the process according to claim 1.

12. A method of using the polyalkylene terephthalate based polymer according to claim 11, the method comprising using the polyalkylene terephthalate based polymer for textile applications, fiber applications, packaging applications, plastic applications, automotive applications, or electronic applications.

13. A method for preparing a product comprising:
(I) providing the polyalkylene terephthalate based polymer according to claim 11; and
(II) preparing a textile, a fiber, a packaging, a plastic, an automotive part, or an electronic part from the polyalkylene terephthalate based polymer provided in (I).

14. The process according to claim 1, further comprising:
converting the residue
to obtain one or more monomer, polymer or polymer product;
and/or
converting the re-obtained polyalkylene terephthalate based polymer obtained by the process to obtain a polymer product.

15. The process according to claim 14,
wherein the monomer is selected from the group consisting of a di- or polyol, aldehyde, di- or polyisocyanate, amide, alkene, alkyne, (di) ester, mono or diacid, diamine, nonanediamine, and sulfones, and/or
wherein the polymer is selected from the group consisting of and/or the polymer product comprises polyamide (PA), polyisocyanate polyaddition product, low-density polyethylene (LDPE), high-density polyethylene (HDPE), polyethylene (PE), polypropylene (PP), polyvinyl chloride (PVC), polyvinyl acetate (PVA), polystyrene (PS), poly acrylonitrile butadiene styrene (ABS), poly styrene acrylonitrile (SAN), poly acrylate styrene acrylonitrile (ASA), polytetrafluoroethylene (PTFE), poly(methyl acrylate) (PMA), poly(methyl methacrylate) (PMMA), polybutadiene (BR, PBD), poly(cis-1,4-isoprene), poly(trans-1,4-isoprene), polyoxymethylene (POM), polyethylene terephthalate (PET), polybutylene terephthalate (PBT), polybutylene adipate coterephthalate (PBAT), polyester (PES), polyether sulfone (PESU), polyhydroxyalkanoate (PHA), poly-3-hydroxybutyrate (P3HB), poly-4-hydroxybutyrate (P4HB), polyhydroxyvalerate (PHV), polyhydroxyhexanoate (PHH), polyhydroxyoctanoate (PHO), polylactic acid (PLA), polysulfone (PSU), polyphenylene sulfone (PPSU), polycarbonate (PC), polyether ether ketone (PEEK), poly(p-phenylene oxide) (PPO), poly(p-phenylene ether) (PPE); or copolymer or mixture thereof; and/or wherein the polymer and/or the polymer product is/are a part of:
a cloth;
an electrical part
a consumer, agricultural product or pharmaceutical product
a packaging for the food industry; or
a part of a construction; and/or
wherein the content of the at least one insoluble polymer selected from the group consisting of PP, PE, PA, natural polymer, viscose and linen and/or of the soluble polymer in the monomer, polymer and/or polymer product is 1 weight-% or more; and/or wherein the content of the at least one insoluble polymer selected from the group consisting of PP, PE, PA, natural polymer, viscose and linen and/or of the soluble polymer in the monomer, polymer and/or polymer product is 100 weight-% or less.

16. The process according to claim 1, wherein (b), if at least one insoluble polymer is present, comprises a residue comprising at least one insoluble polymer selected from PP, PE, PA, natural polymer, viscose and linen.

17. The process according to claim 7, wherein cooling in (c.1) is done without addition of anti-solvents.

18. The process according to claim 1, wherein the process comprises:
(f) drying the precipitated polyalkylene terephthalate based polymer obtained in (d) or the washed precipitated polyalkylene terephthalate based polymer obtained in (e).

19. The process according to claim 1, comprising, if at least one soluble polymer different from polyalkylene terephthalate is present in the polymeric material:
(x) contacting the polymeric material with a solvent system at a temperature T₁ of ≤160 °C,
wherein step (x) is carried out prior to step (b) and
wherein the soluble polymer comprises an elastic fiber.

20. The polyalkylene terephthalate based polymer from the process according to claim 1, obtained from steps (d), (e), (f) or (x).
